(19) United States
(12) Patent Application Publication
(10) Pub. No.: US 2015/0371254 A1
(43) Pub. Date: Dec. 24, 2015

(54) SYSTEM AND METHOD FOR PRESENTING VIRTUAL DISCOUNT COUPONS TO CUSTOMERS OF A RETAIL ENTERPRISE BASED ON SHOPPING HISTORY

(71) Applicant: Meijer, Inc., Grand Rapids, MI (US)

(72) Inventors: Brian Pugh, Grand Rapids, MI (US); K. Michael Ross, Grand Rapids, MI (US); Elmer L. Robinson, JR., Marne, MI (US); Michael William Vendal, Champaign, IL (US)

(73) Assignee: Meijer, Inc.

(21) Appl. No.: 14/743,876

(22) Filed: Jun. 18, 2015

Related U.S. Application Data
(60) Provisional application No. 62/015,391, filed on Jun. 20, 2014.

(51) Int. Cl. G06Q 30/02

(52) U.S. Cl. CPC G06Q 30/0224

(57) ABSTRACT

A system and method for presenting virtual discount coupons to customers of a retail enterprise accesses a virtual coupon repository stored in a database and containing a plurality of virtual discount coupons each redeemable against at least one item purchasable from the retail enterprise, accesses a purchase history stored in the database and identifying items previously purchased by the customer from the retail enterprise, for each virtual discount coupon in at least a subset of the plurality of virtual discount coupons in the virtual coupon repository, determines a prediction value based on the purchase history, which corresponds to a likelihood that the customer will purchase an item from the retail enterprise against which the virtual discount coupon is redeemable, and identifies for the customer in the virtual coupon repository at least one of the virtual discount coupons based on the prediction value thereof.

### CROSS-REFERENCE TO RELATED APPLICATION

This patent application claims the benefit of, and priority to, U.S. Provisional Patent Application Ser. No. 62/015,391, filed Jun. 20, 2014, the disclosure of which is incorporated herein by reference.

### FIELD OF THE INVENTION

The present invention relates generally to systems for providing customers of retail enterprises with redeemable virtual discount coupons, and more specifically to systems for presenting such virtual discount coupons to customers based on customer shopping history.

### BACKGROUND

Retailers of goods and services typically offer such goods and services for purchase via one or more conventional brick-and-mortar retail stores and/or via one or more Internet-accessible websites, i.e., one or more websites accessible via a global system of interconnected computer networks. It may be desirable for retailers to make available to their customers discounts offered by product manufacturers and/or service providers against the purchase of their goods and/or services. It may further be desirable, in the case of goods and/or services offered for sale via one or more brick-and-mortar retail stores, and/or in the case of goods and/or services offered for sale via one or more Internet-accessible websites, for retailers to make such discount offers available in a manner that enhances the shopping experience of their customers.

### SUMMARY

The present invention may comprise one or more of the features recited in the attached claims, and/or one or more of the following features and combinations thereof. In a first example aspect, a method for presenting virtual discount coupons to customers of a retail enterprise may include accessing with a processor a virtual coupon repository stored in a database and associated in the database with a customer of the retail enterprise, the virtual coupon repository containing a plurality of virtual discount coupons each redeemable by the retail enterprise against at least one item purchasable from the retail enterprise, accessing with the processor a purchase history stored in the database and associated in the database with the customer, the purchase history identifying items previously purchased by the customer from the retail enterprise, for each virtual discount coupon in at least a subset of the plurality of virtual discount coupons in the virtual coupon repository, determining with the processor a prediction value based on the purchase history, the prediction value corresponding to a likelihood that the customer will purchase an item from the retail enterprise against which the virtual discount coupon is redeemable by the retail enterprise, and with the processor, identifying for the customer in the virtual coupon repository at least one of the virtual discount coupons in the at least the subset of the plurality of virtual discount coupons based the prediction value thereof.

A second example aspect includes the subject matter of the first example aspect and wherein the at least the subset of the plurality of virtual discount coupons includes one of all of the plurality of virtual discount coupons and a number of the plurality of virtual discount coupons that is less than all of the plurality of virtual discount coupons.

A third example aspect includes the subject matter of the first example aspect and further includes sorting with the processor at least some the virtual discount coupons in the at least the subset of the plurality of virtual discount coupons based the prediction values thereof in order of the likelihood that the customer will purchase items against which corresponding ones of the virtual discount coupons are redeemable by the retail enterprise, and wherein identifying the at least one of the virtual discount coupons may include identifying for the customer in the virtual coupon repository one or more of the virtual discount coupons resulting from the sorting.

A fourth example aspect includes the subject matter of the third example aspect and wherein sorting with the processor the at least some of the virtual discount coupons produces a descending sorted list of virtual discount coupons in which a virtual discount coupon at one end of the sorted list is redeemable by the retail enterprise against an item determined by the processor to have greatest likelihood of being purchased by the customer from the retail enterprise and in which a virtual discount coupon at an opposite end of the sorted list is redeemable by the retail enterprise against an item determined by the processor to have least likelihood of being purchased by the customer from the retail enterprise, and wherein identifying the at least one of the virtual discount coupons may include identifying for the customer in the virtual coupon repository one or more of the virtual discount coupons at or near the one end of the sorted list.

A fifth example aspect includes the subject matter of the first example aspect and further includes accessing with the processor a coupon activity history stored in the database and associated in the database with the customer, the coupon activity history containing identifications of virtual discount coupon processing actions previously executed by the customer on one or more virtual discount coupons previously contained in the virtual coupon repository associated with the customer, and for each virtual discount coupon in the at least the subset of the plurality of virtual discount coupons in the virtual coupon repository, determining with the processor, based on one or more of the identifications of virtual discount coupon processing actions contained in the coupon activity history, at least one of: a first score value proportional to a total number of virtual discount coupons that were previously clipped by the customer within the virtual coupon repository for redemption by the retail enterprise against corresponding items purchased from the retail enterprise, a second score value proportional to a number of virtual discount coupons, within one of a plurality of different coupon categories contained in the virtual coupon repository in which the virtual discount coupon is a member, that were previously clipped by the customer within the virtual coupon repository for redemption by the retail enterprise against corresponding items purchased from the retail enterprise, and a third score value proportional to a number of virtual coupons previously hidden by the customer from view within the virtual coupon repository, and determining a composite score for the virtual discount coupon as a function of the prediction value and the at least one of the first, second and third score values, and wherein identifying may include identifying for the customer in the virtual coupon repository at least one of the virtual discount coupons in the at least the subset of the plurality of virtual coupons having a composite score that is within a predefined range of composite scores.

A sixth example aspect includes the subject matter of the fifth example aspect and wherein identifying may include identifying for the customer in the virtual coupon repository at least one of the virtual discount coupons in the at least the subset of the plurality of virtual coupons having a composite score that is greater than a predefined composite score.

A seventh example aspect includes the subject matter of the fifth example aspect and further includes, for each virtual discount coupon in the at least the subset of the plurality of virtual discount coupons in the virtual coupon repository, modifying the prediction value with a prediction weighting value, modifying the at least one of the first, second and third score values with at least one of first, second and third weighting values respectively, and determining the composite score as a function of the prediction value modified by the prediction weighting value and of the at least one of the first, second and third score values modified by the at least one of the first, second and third weighting values respectively.

An eighth example aspect includes the subject matter of the fifth example aspect and further includes sorting the composite scores in descending order, and wherein identifying may include arranging for the customer in the virtual coupon repository one or more of the virtual discount coupons according to the sorted composite scores.

A ninth example aspect includes the subject matter of the first example aspect and further includes automatically clipping, with the processor, for redemption by the retail enterprise at least one of the virtual discount coupons identified in the virtual coupon repository by the processor based on the prediction value thereof.

A tenth example aspect includes the subject matter of the ninth example aspect and wherein automatically clipping may include automatically clipping the at least one of the virtual discount coupons identified in the virtual coupon repository by the processor based on the prediction value thereof in response to selection by the customer of a selectable, automatic clipping feature available in the virtual coupon repository.

In an eleventh example aspect, a system for presenting virtual discount coupons to customers of a retail enterprise may include a virtual coupon repository database including a plurality of virtual coupon repositories each associated with a different one of a plurality of customers of the retail enterprise, each of the plurality of virtual discount coupon repositories containing a plurality of virtual discount coupons each redeemable by the retail enterprise against at least one item purchasable by an associated one of the plurality of customers from the retail enterprise, a purchase history database including a plurality of purchase histories each associated with a different one of the plurality customers, each of the plurality of purchase histories containing identifications of items previously purchased by an associated one of the plurality of customers from the retail enterprise, a processor, and a memory having instructions stored therein which, when executed by the processor, cause the processor to access the one of the plurality of virtual coupon repositories associated in the virtual coupon repository database with one of the plurality of customers, access the one of the purchase histories associated in the purchase history database with the one of the plurality of customers, for each virtual discount coupon in at least a subset of the plurality of virtual discount coupons in the one of the plurality of virtual coupon repositories, determine a prediction value based on identifications of items in the one of the plurality of purchase histories previously purchased by the one of the plurality of customers, the prediction value corresponding to a likelihood that the one of the plurality of customers will purchase an item from the retail enterprise against which the virtual discount coupon is redeemable by the retail enterprise, and to identify for the customer in the one of the virtual coupon repositories at least one of the virtual discount coupons in the at least a subset of the plurality of virtual discount coupons based the prediction value thereof.

A twelfth example aspect includes the subject matter of the eleventh example aspect and wherein the instructions stored in the memory further include instructions which, when executed by the processor, cause the processor to sort the virtual discount coupons in the at least the subset of the plurality of virtual discount coupons in order of the likelihood that the one of the plurality of customers will purchase items against which corresponding ones of the virtual discount coupons are redeemable by the retail enterprise, and to identify the at least one of the virtual discount coupons by identifying for the one of the plurality of customers in the one of the plurality of virtual coupon repositories one or more of the virtual discount coupons resulting from the sorting.

A thirteenth example aspect includes the subject matter of the eleventh example aspect and wherein the instructions stored in the memory further include instructions which, when executed by the processor, cause the processor to sort the virtual discount coupons in the at least the subset of the plurality of virtual discount coupons to produce a descending sorted list of virtual discount coupons in which a virtual discount coupon at one end of the sorted list is redeemable by the retail enterprise against an item determined to have greatest likelihood of being purchased by the one of the plurality of customers from the retail enterprise and in which a virtual discount coupon at an opposite end of the sorted list is redeemable by the retail enterprise against an item determined to have least likelihood of being purchased by the one of the plurality of customers from the retail enterprise, and to identify the at least one of the virtual discount coupons by identifying for the one of the plurality of customers in the one of the plurality of virtual coupon repositories one or more of the virtual discount coupons at or near the one end of the sorted list.

A fourteenth example aspect includes the subject matter of the eleventh example aspect and further includes a coupon activity history database including a plurality of coupon activity histories each associated with a different one of the plurality customers, each of the plurality of coupon activity histories containing identifications of virtual coupon processing actions previously executed by an associated one of the plurality of customers on one or more virtual discount coupons previously contained in the one of the plurality of virtual coupon repositories associated with the one of the plurality of customers, and wherein the instructions stored in the memory further include instructions which, when executed by the processor, cause the processor to, for each virtual discount coupon in the at least the subset of the plurality of virtual discount coupons in the one of the virtual coupon repositories, determine, based on one or more of the identifications of virtual discount coupon processing actions contained in the one of the coupon activity histories associated in the coupon activity database with the one of the plurality of customers, at least one of: a first score value proportional to a total number of virtual discount coupons that were previously clipped by the one of the plurality of customers within the one of the plurality of virtual coupon repositories for redemption by the retail enterprise against corresponding items purchased from the retail enterprise, a second score value proportional to a number of virtual discount coupons, within one of a plurality of different coupon categories contained in the one of the virtual coupon repositories in which the virtual discount coupon is a member, that were previously clipped by the one of the plurality of customers within the one of the plurality of virtual coupon repositories for redemption by the retail enterprise against corresponding items purchased from the retail enterprise, and a third score value proportional to a number of virtual coupons previously hidden by the one of the plurality of customers from view within the one of the plurality of virtual coupon repositories, and determine a composite score for the virtual discount coupon as a function of the prediction value and the at least one of the first, second and third score values, and to identify for the one of the plurality of customers in the one of the plurality of virtual coupon repositories at least one of the virtual discount coupons by identifying at least one of the virtual discount coupons in the at least the subset of the plurality of virtual coupons having a composite score that is within a predefined range of composite scores.

A fifteenth example aspect includes the subject matter of the fourteenth example aspect and wherein the instructions stored in the memory further include instructions which, when executed by the processor, cause the processor to identify the at least one of the virtual discount coupons in the at least the subset of the plurality of virtual coupons by identifying at least one of the virtual discount coupons having a composite score that is greater than a predefined composite score.

A sixteenth example aspect includes the subject matter of the fourteenth example aspect and wherein the instructions stored in the memory further include instructions which, when executed by the processor, cause the processor to, for each virtual discount coupon in the at least the subset of the plurality of virtual discount coupons in the one of the virtual coupon repositories, modify the prediction value with a prediction weighting value, modify the at least one of the first, second and third score values with at least one of first, second and third weighting values respectively, and determine the composite score for the virtual discount coupon as a function of the prediction value modified by the prediction weighting value and of the at least one of the first, second and third score values modified by the at least one of the first, second and third weighting values respectively.

A seventeenth example aspect includes the subject matter of the fourteenth example aspect and wherein the instructions stored in the memory further include instructions which, when executed by the processor, cause the processor to sort the composite scores in descending order, and to identify the at least one of the virtual discount coupons in the at least the subset of the plurality of virtual coupons by arranging for the one of the plurality of customers in the one of the plurality of virtual coupon repositories one or more of the virtual discount coupons according to the sorted composite scores.

An eighteenth example aspect includes the subject matter of the fourteenth example aspect and wherein the instructions stored in the memory further include instructions which, when executed by the processor, cause the processor to automatically clip for redemption by the retail enterprise at least one of the virtual discount coupons identified in the one of the plurality of virtual coupon repositories based on the prediction value thereof.

A nineteenth example aspect includes the subject matter of the eighteenth example aspect and wherein the instructions stored in the memory further include instructions which, when executed by the processor, cause the processor to automatically clip the at least one of the virtual discount coupons by automatically clipping the at least one of the virtual discount coupons identified in the one of the plurality of virtual coupon repositories in response to selection by the one of the plurality of customers of a selectable, automatic clipping feature available in the one of the plurality of virtual coupon repositories.

In a twentieth example aspect, a system for presenting virtual discount coupons to customers of a retail enterprise may include a virtual coupon repository associated with a customer of the retail enterprise, the virtual coupon repository containing a plurality of virtual discount coupons each redeemable by the retail enterprise against at least one item purchasable from the retail enterprise, a purchase history database containing a purchase history associated with the customer, the purchase history identifying items previously purchased by the customer from the retail enterprise, a coupon activity history database containing a coupon activity history associated with the customer, the coupon activity history containing identifications of virtual discount coupon processing actions previously executed by the customer on one or more virtual discount coupons previously contained in the virtual coupon repository associated with the customer, a customer purchase history management module to access the purchase history database, a customer virtual coupon activity history management module to access the coupon activity history database, a virtual coupon processing module to determine, for each virtual discount coupon in at least a subset of the plurality of virtual discount coupons in the virtual coupon repository, a prediction value based on identifications of items in the purchase histories previously purchased by the customer, the prediction value corresponding to a likelihood that the customer will purchase an item from the retail enterprise against which the virtual discount coupon is redeemable by the retail enterprise, at least one of a first score value, a second score value and a third score value, based on one or more of the identifications of virtual discount coupon processing actions contained in the coupon activity history, the first score value proportional to a total number of virtual discount coupons that were previously clipped by the customer within the virtual coupon repository for redemption by the retail enterprise against corresponding items purchased from the retail enterprise, the second score value proportional to a number of virtual discount coupons, within one of a plurality of different coupon categories contained in the virtual coupon repository in which the virtual discount coupon is a member, that were previously clipped by the customer within the virtual coupon repository for redemption by the retail enterprise against corresponding items purchased from the retail enterprise, and the third score value proportional to a number of virtual coupons previously hidden by the customer from view within the virtual coupon repository, and a composite score for the virtual discount coupon as a function of the prediction value and the at least one of the first, second and third score values, and a virtual coupon arrangement module to identify for the customer in the virtual coupon repository at least one of the virtual discount coupons in the at least the subset of the plurality of virtual coupons having a composite score that is within a predefined range of composite scores.

In a twenty first example aspect, a method for redeeming virtual coupons during a purchase transaction may include price scanning an item presented for purchase by a customer at a point-of-sale system of a retail enterprise using a price scanner, accessing with a processor a virtual coupon repository associated with the customer and maintained by the retail enterprise, the virtual coupon repository containing a plurality of virtual discount coupons that are not clipped for redemption against corresponding items purchasable from the retail enterprise, comparing with the processor the price scanned item with each of the plurality of virtual discount coupons contained in the virtual coupon repository, if the price scanned item matches one of the plurality of virtual discount coupons contained in the virtual coupon repository, clipping with the processor the matched one of the plurality of virtual discount coupons for redemption by the retail enterprise against the price scanned item, and redeeming the clipped virtual discount coupon against the price scanned item by deducting with the point-of-sale system a discount amount of the virtual discount coupon from a price of the price scanned item.

In a twenty second example aspect, a system for redeeming virtual coupons during a purchase transaction may include a virtual coupon repository associated with the customer and maintained by the retail enterprise, the virtual coupon repository containing a plurality of virtual discount coupons that are not clipped for redemption against corresponding items purchasable from the retail enterprise, a point-of-sale system associated with a retail enterprise, a price scanner at the point-of-sale system, at least one processor, and a memory having instructions stored therein which, when executed by the at least one processor, cause the at least one processor to control the price scanner to price scan an item presented for purchase by a customer at the point-of-sale system, to access the virtual coupon repository, to compare the price scanned item with each of the plurality of virtual discount coupons contained in the virtual coupon repository, and if the price scanned item matches one of the plurality of virtual discount coupons contained in the virtual coupon repository, to clip the matched one of the plurality of virtual discount coupons for redemption by the retail enterprise against the price scanned item, and to redeem the clipped virtual discount coupon against the price scanned item by deducting a discount amount of the virtual discount coupon from a price of the price scanned item.

A twenty third example aspect includes the subject matter of the twenty second example and further includes one or more virtual discount coupons that have been clipped by the customer for redemption by the retail enterprise against corresponding items purchasable from the retail enterprise, and wherein the memory further has instructions stored therein which, when executed by the at least one processor, cause the at least one processor to control the price scanner to price scan multiple items presented for purchase by the customer at the point-of-sale system of the retail enterprise, and to redeem the one or more virtual discount coupons that have been clipped by the customer by controlling the point-of-sale system to deduct a discount amount of each of the one or more virtual discount coupons that have been clipped by the customer from a price of a corresponding one of the multiple price scanned items.

A twenty fourth example aspect includes the subject matter of the twenty third example aspect and wherein the memory further has instructions stored therein which, when executed by the at least one processor, cause the at least one processor to compare each of the multiple price scanned items with each of the one or more virtual discount coupons that have been clipped by the customer, and to redeem the one or more virtual discount coupons that have been clipped by the customer by controlling the point-of-sale system to deduct a discount amount of each of the one or more virtual discount coupons that have been clipped by the customer from a price of a matching one of the multiple price scanned items.

A twenty fifth example aspect includes the subject matter of the twenty second aspect and further includes a clipped virtual coupon repository associated with the customer, and wherein the memory further has instructions stored therein which, when executed by the at least one processor, cause the at least one processor to move each virtual discount coupon that has been clipped by the customer or by the processor to the clipped virtual coupon repository, delete the clipped virtual discount coupon from the virtual coupon repository associated with the customer, and delete each clipped virtual discount coupon from the clipped virtual coupon repository after redemption thereof.

A twenty sixth example aspect includes the subject matter of the twenty second example aspect and wherein the memory further has instructions stored therein which, when executed by the at least one processor, cause the at least one processor to control the price scanner to price scan multiple items presented for purchase by the customer at the point-of-sale system of the retail enterprise, to compare each of the multiple price scanned items with each of the plurality of virtual discount coupons contained in the virtual coupon repository, to clip each of the plurality of virtual discount coupons contained in the virtual coupon repository that matches one of the multiple price scanned items, and to redeem each of the clipped virtual discount coupons against a matched one of the multiple price scanned item by controlling the point-of-sale system to deduct a discount amount of the clipped virtual discount coupon from a price of a matched one of the multiple price scanned items.

In a twenty seventh example aspect, a system for redeeming virtual coupons during a purchase transaction may include a virtual coupon repository associated with the customer and maintained by the retail enterprise, the virtual coupon repository containing a plurality of virtual discount coupons that are not clipped for redemption against corresponding items purchasable from the retail enterprise, a point-of-sale system associated with a retail enterprise, a price scanner at the point-of-sale system, a transaction module to control the price scanner to price scan an item presented for purchase by a customer at the point-of-sale system, and a virtual coupon processing module to access the virtual coupon repository, to compare the price scanned item with each of the plurality of virtual discount coupons contained in the virtual coupon repository, and if the price scanned item matches one of the plurality of virtual discount coupons contained in the virtual coupon repository, to clip the matched one of the plurality of virtual discount coupons for redemption by the retail enterprise against the price scanned item, and wherein the transaction module to redeem the clipped virtual discount coupon against the price scanned item by deducting a discount amount of the virtual discount coupon from a price of the price scanned item.

In a twenty eighth example aspect, a non-transitory machine-readable medium may include a plurality of instructions which, when executed by at least one processor, result in the at least one processor accessing a virtual coupon repository stored in a database and associated in the database with a customer of the retail enterprise, the virtual coupon repository containing a plurality of virtual discount coupons each redeemable by the retail enterprise against at least one item purchasable from the retail enterprise, accessing a purchase history stored in the database and associated in the database with the customer, the purchase history identifying items previously purchased by the customer from the retail enterprise, for each virtual discount coupon in at least a subset of the plurality of virtual discount coupons in the virtual coupon repository, determining a prediction value based on the purchase history, the prediction value corresponding to a likelihood that the customer will purchase an item from the retail enterprise against which the virtual discount coupon is redeemable by the retail enterprise, and identifying for the customer in the virtual coupon repository at least one of the virtual discount coupons in the at least a subset of the plurality of virtual discount coupons based the prediction value thereof.

A twenty ninth example aspect includes the subject matter of the twenty eighth example aspect and wherein the instructions which, when executed by the at least one processor, further result in the at least one processor accessing a coupon activity history stored in the database and associated in the database with the customer, the coupon activity history containing identifications of virtual discount coupon processing actions previously executed by the customer on one or more virtual discount coupons previously contained in the virtual coupon repository associated with the customer, and for each virtual discount coupon in the at least the subset of the plurality of virtual discount coupons in the virtual coupon repository, determining, based on one or more of the identifications of virtual discount coupon processing actions contained in the coupon activity history, at least one of: a first score value proportional to a total number of virtual discount coupons that were previously clipped by the customer within the virtual coupon repository for redemption by the retail enterprise against corresponding items purchased from the retail enterprise, a second score value proportional to a number of virtual discount coupons, within one of a plurality of different coupon categories contained in the virtual coupon repository in which the virtual discount coupon is a member, that were previously clipped by the customer within the virtual coupon repository for redemption by the retail enterprise against corresponding items purchased from the retail enterprise, and a third score value proportional to a number of virtual coupons previously hidden by the customer from view within the virtual coupon repository, and determining a composite score for the virtual discount coupon as a function of the prediction value and the at least one of the first, second and third score values, and wherein identifying includes identifying for the customer in the virtual coupon repository at least one of the virtual discount coupons in the at least the subset of the plurality of virtual coupons having a composite score that is within a predefined range of composite scores.

In a thirtieth example aspect, a non-transitory machine-readable medium may include a plurality of instructions which, when executed by at least one processor, result in the at least one processor controlling a price scanner to price scan an item presented for purchase by a customer at a point-of-sale system of a retail enterprise, accessing a virtual coupon repository associated with the customer and maintained by the retail enterprise, the virtual coupon repository containing a plurality of virtual discount coupons that are not clipped for redemption against corresponding items purchasable from the retail enterprise, comparing the price scanned item with each of the plurality of virtual discount coupons contained in the virtual coupon repository, if the price scanned item matches one of the plurality of virtual discount coupons contained in the virtual coupon repository, clipping the matched one of the plurality of virtual discount coupons for redemption by the retail enterprise against the price scanned item, and controlling the point-of-sale system to redeem the clipped virtual discount coupon against the price scanned item by deducting a discount amount of the virtual discount coupon from a price of the price scanned item.

In a thirty first example aspect, a method for presenting limited term product advertisements to customers of a retail enterprise may include accessing with a processor a product advertisement bank stored in a database, the product advertisement bank containing a plurality of virtual product advertisements each identifying limited term discount pricing of at least one item purchasable from at least one of a plurality of retail enterprise outlets controlled by the retail enterprise, accessing with the processor a purchase history stored in the database and associated in the database with a customer, the purchase history identifying items previously purchased by the customer from the retail enterprise, for each virtual product advertisement in at least a subset of the plurality of virtual product advertisements in the product advertisement bank, determining with the processor a prediction value based on the purchase history, the prediction value corresponding to a likelihood that the customer will purchase an item from the retail enterprise to which the limited term discount pricing of the virtual product advertisement is applicable, and with the processor, identifying for the customer in the virtual product advertisement bank at least one of the virtual product advertisements in the at least the subset of the plurality of virtual product advertisements based the prediction value thereof.

A thirty second example aspect includes the subject matter of the thirty first example aspect and wherein the product advertisement bank contains a plurality of product advertisement repositories each containing a plurality of virtual product advertisements for a different one of the plurality of retail enterprise outlets controlled by the retail enterprise which identify limited term discount pricing of at least one item purchasable from the one of the plurality of retail enterprise outlets, and wherein accessing the product advertisement bank includes accessing one of the plurality of product advertisement repositories, and wherein determining the prediction value comprises, for each virtual product advertisement in at least a subset of the plurality of virtual product advertisements in the one of the plurality of product advertisement repositories, determining with the processor a prediction value based on the purchase history, the prediction value corresponding to a likelihood that the customer will purchase from the one of the plurality of retail enterprise outlets an item to which the limited term discount pricing of the virtual product advertisement is applicable, and with the processor, identifying for the customer in the one of the plurality of virtual product advertisement repositories at least one of the virtual product advertisements in the at least the subset of the plurality of virtual product advertisements in the one of the plurality of product advertisement repositories based the prediction value thereof.

A thirty third example aspect includes the subject matter of the thirty second example aspect and further includes, for each virtual product advertisement in the at least the subset of the plurality of virtual product advertisements in the one of the plurality of product advertisement repositories, determining with the processor, based the purchase history, at least one of: a first score value proportional to a total number of items previously purchased by the customer from the retail enterprise to which the limited term discount pricing of a virtual product advertisement was applicable, and a second score value proportional to a number of items within one of a plurality of different product advertisement categories contained in the product advertisement bank or in the one of the plurality of product advertisement repositories in which the virtual product advertisement is a member, previously purchased by the customer from the retail enterprise to which the limited term discount pricing of a virtual product advertisement was applicable, and determining a composite score for the virtual discount coupon as a function of the prediction value and the at least one of the first and second score values, and wherein identifying comprises identifying for the customer in the one of the plurality of virtual product advertisement repositories at least one of the virtual product advertisements in the at least the subset of the plurality of virtual product advertisements having a composite score that is within a predefined range of composite scores.

A thirty fourth example aspect includes the subject matter of the thirty third example aspect and wherein identifying includes identifying for the customer in the one of the plurality of virtual product advertisement repositories at least one of the virtual product advertisements in the at least the subset of the plurality of virtual product advertisements having a composite score that is greater than a predefined composite score.

A thirty fifth example aspect includes the subject matter of the thirty fourth aspect and further includes, for each virtual product advertisement in at least a subset of the plurality of virtual product advertisements in the one of the plurality of product advertisement repositories, modifying the prediction value with a prediction weighting value, modifying the at least one of the first and second score values with at least one of first and second weighting values respectively, and determining the composite score as a function of the prediction value modified by the prediction weighting value and of the at least one of the first and second score values modified by the at least one of the first and second weighting values respectively.

In a thirty sixth example aspect, a system for presenting limited term product advertisements to customers of a retail enterprise may include a product advertisement database containing a plurality of product advertisement repositories each containing a plurality of virtual product advertisements for a different one of a plurality of retail enterprise outlets controlled by the retail enterprise, each of the plurality of virtual product advertisements identifying limited term discount pricing of at least one item purchasable from a corresponding one of the plurality of retail enterprise outlets controlled by the retail enterprise, a purchase history database including a plurality of purchase histories each associated with a different one of the plurality customers, each of the plurality of purchase histories containing identifications of items previously purchased by an associated one of the plurality of customers from the retail enterprise, a processor, and a memory having instructions stored therein which, when executed by the processor, cause the processor to access one of the plurality of product advertisement repositories, access one of the plurality of purchase histories associated in the purchase history database with one of the plurality of customers, for each virtual product advertisement in at least a subset of the plurality of virtual product advertisements in the one of the plurality of product advertisement repositories, determining with the processor a prediction value based on the purchase history, the prediction value corresponding to a likelihood that the customer will purchase an item to which the limited term discount pricing of the virtual product advertisement is applicable from the one of the retail enterprise outlets corresponding to the one of the plurality of product advertisement repositories, and to identify for the one of the plurality of customers in the one of the plurality of virtual product advertisement repositories at least one of the virtual product advertisements in the at least the subset of the plurality of virtual product advertisements based the prediction value thereof.

A thirty seventh example aspect includes the subject matter of the thirty sixth example aspect and wherein the instructions stored in the memory further include instructions which, when executed by the processor, cause the processor to, for each virtual product advertisement in the at least the subset of the plurality of virtual product advertisements in the one of the plurality of product advertisement repositories, determine, based the one of the plurality of purchase histories, at least one of a first score value proportional to a total number of items previously purchased by the one of the plurality of customers from the retail enterprise to which the limited term discount pricing of a virtual product advertisement was applicable, and a second score value proportional to a number of items within one of a plurality of different product advertisement categories contained in the one of the plurality of product advertisement repositories in which the virtual product advertisement is a member, previously purchased from the one of the plurality of retain enterprise outlets by the one of the plurality of customers from the retail enterprise and to which the limited term discount pricing of a virtual product advertisement was applicable, and to determine a composite score for the virtual discount coupon as a function of the prediction value and the at least one of the first and second score values, and to identify the at least one of the virtual product advertisements by identifying for the customer in the one of the plurality of virtual product advertisement repositories at least one of the virtual product advertisements in the at least the subset of the plurality of virtual product advertisements having a composite score that is within a predefined range of composite scores.

A thirty eighth example aspect includes the subject matter of the thirty seventh example aspect and wherein the instructions stored in the memory further include instructions which, when executed by the processor, cause the processor to identify the at least one of the virtual product advertisements by identifying for the customer in the one of the plurality of virtual product advertisement repositories at least one of the virtual product advertisements in the at least the subset of the plurality of virtual product advertisements having a composite score that is greater than a predefined composite score.

A thirty ninth example aspect includes the subject matter of the thirty eighth example aspect and wherein the instructions stored in the memory further include instructions which, when executed by the processor, cause the processor to, for each virtual product advertisement in the at least the subset of the plurality of virtual product advertisements in the one of the plurality of product advertisement repositories, modify the prediction value with a prediction weighting value, modify the at least one of the first and second score values with at least one of first and second weighting values respectively, and determine the composite score as a function of the prediction value modified by the prediction weighting value and of the at least one of the first and second score values modified by the at least one of the first and second weighting values respectively.

### BRIEF DESCRIPTION OF THE DRAWINGS

This disclosure is illustrated by way of example and not by way of limitation in the accompanying figures. Where considered appropriate, reference labels have been repeated among the figures to indicate corresponding or analogous elements.

FIG. 1 is a simplified block diagram of an embodiment of a system for presenting virtual discount coupons to customers of a retail enterprise based on their shopping history.

FIG. 2 is a simplified block diagram of an embodiment of one of the point-of-sale systems illustrated in FIG. 1.

FIG. 3A is a simplified block diagram of an embodiment of one of the mobile communication devices illustrated in FIG. 1.

FIG. 3B is a simplified block diagram of an embodiment of one of the user computing devices illustrated in FIG. 1.

FIG. 4 is a simplified block diagram of an embodiment of a software environment of the main server of FIG. 1.

FIG. 5 is a simplified flow diagram of an embodiment of a process for presenting virtual coupons to customers of the retail enterprise based on shopping history,

FIG. 6 is a simplified flow diagram of an embodiment of the virtual coupon sorting step illustrated in FIG. 5,

FIG. 7 is a simplified diagram of a display device screen shot illustrating an example arrangement of virtual coupons within an example customer's virtual coupon page(s).

FIG. 8 is a simplified diagram of a display device screen shot illustrating another example arrangement of virtual coupons with an example customer's virtual coupon page(s).

FIG. 9 is a simplified diagram of a display device screen shot illustrating yet another example arrangement of virtual coupons with an example customer's virtual coupon page(s).

FIG. 10 is a simplified diagram of a display device screen shot illustrating still another example arrangement of virtual coupons with an example customer's virtual coupon page(s).

FIG. 11 is a simplified flow diagram of an embodiment of a process for clipping virtual coupons within a customer's virtual coupon page for subsequent redemption during a product purchase transaction with the retail enterprise.

FIG. 12 is a simplified flow diagram of an embodiment of a process for redeeming virtual coupons by a customer during a product purchase transaction with the retail enterprise.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure, process, process step or characteristic is described in connection with an embodiment, it is submitted that it is within the knowledge of one skilled in the art to effect such feature, structure, process, process step or characteristic in connection with other embodiments whether or not explicitly described. Further still, it is contemplated that any single feature, structure, process, process step or characteristic disclosed herein may be combined with any one or more other disclosed feature, structure, process, process step or characteristic, whether or not explicitly described, and that no limitations on the types and/or number of such combinations should therefore be inferred.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on one or more machine-readable media, which may be read and executed by one or more processors. A machine-readable medium may be embodied as any device or physical structure for storing or transmitting information in a form readable by a machine (e.g., a computing device). For example, a machine-readable medium may be embodied as any one or combination of read only memory (ROM); random access memory (RAM); magnetic disk storage media; optical storage media; flash memory devices; and others.

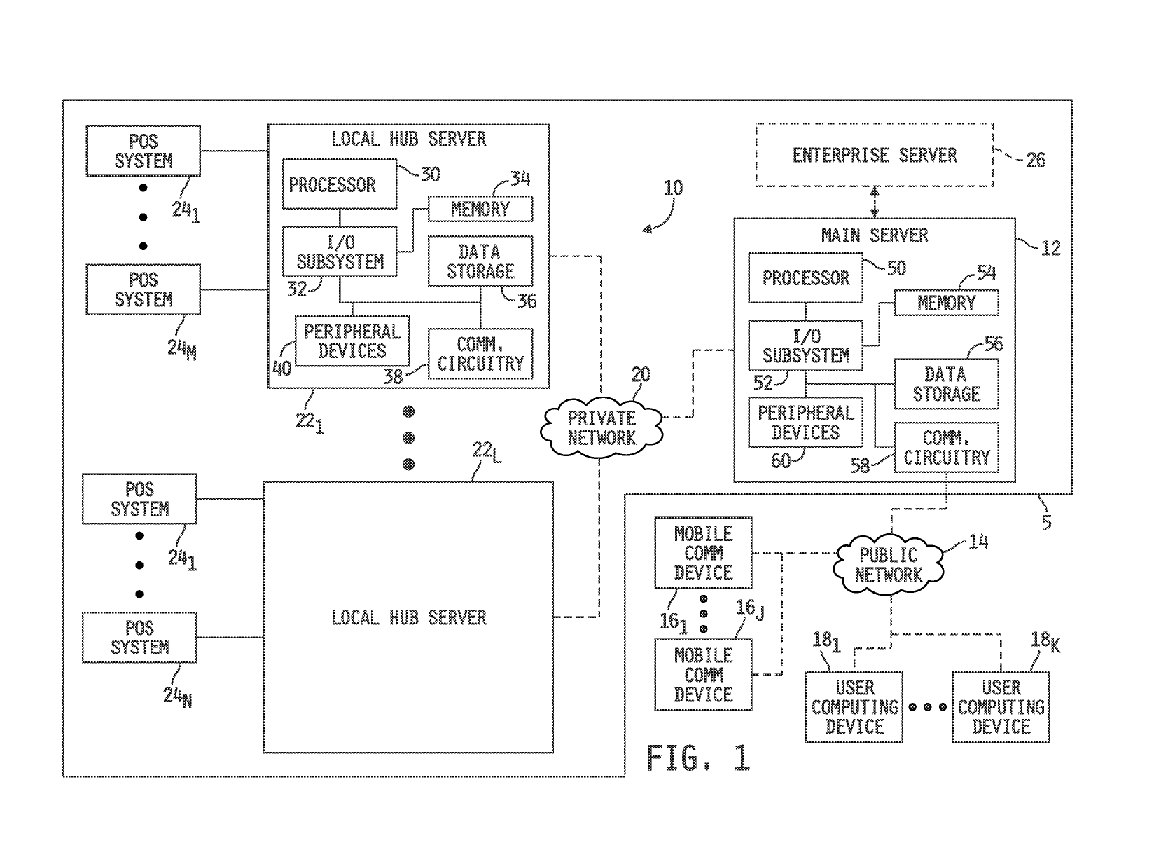

Referring now to FIG. 1, a system 10 is shown for presenting virtual discount coupons to customers of a retail enterprise based on their shopping history. The system 10 includes a main server 12 configured to communicate with shoppers via a public network 14, e.g., the Internet, and shoppers may access the public network 14 using any conventional public network accessible electronic device and/or system. In the illustrated embodiment, for example a number, J, of mobile communication devices 16₁-16_{J}, and a number, K, of user computing devices 18₁-18_{K}, are shown. Each is configured to communicatively connect to the public network 14, and J and K may each be any positive integer. The main server 12 is further configured to communicate with a number of point-of-sale systems 24₁-24_{M}, 24₁-24_{N}, each of which operate in a conventional manner to process items to be purchased by shoppers during purchase transactions.

In one embodiment, the main server 12 is illustratively part of, and serves, a retail enterprise 5 which may include any number of brick-and-mortar retail outlets each having one or more point-of-sale systems 24₁-24_{M}, 24₁-24_{N} operating therein. Alternatively or additionally, the retail enterprise may control and operate a web-based purchase interface via which customers of the retail enterprise may purchase products and/or services in a conventional manner. For purposes of this document, the term “purchase interface” should be understood to refer to such a web-based purchase interface and/or to a point-of-sale system, e.g., one or more of the point-of-sale systems 24₁-24_{M}, 24₁-24_{N}.

The main server 12 in some embodiments illustratively hosts an enterprise member services (EMS) program which includes or otherwise has access to an offer bank database containing a plurality of virtual discount offers, e.g., virtual discount coupons, and a discount offer repository in which to store and manage virtual discount offers provided from the offer bank database to each customer-member of the EMS program. As will be discussed in detail below, the main server 12 illustratively includes a discount offer management module that manages and controls a customer-member interface, e.g., a web-based interface, to the EMS system via which customers can access and manage their individual discount offer repositories, that collects and stores over time the purchase history of each customer-member of the EMS, and that controls the presentation of virtual discount offers in each customer-member interface based on the purchase history of the customer-member.

In the embodiment illustrated in FIG. 1, the main server 12 is coupled via a private network 20 to a plurality of local hub servers 22₁-22_{L}, where L may be any positive integer, and each local hub server 22₁-22_{L} is coupled to one or more of conventional point-of-sale systems, e.g., 24₁-24_{M}, 24₁-24_{N}. Each of the point-of-sale systems 24₁-24_{M}, 24₁-24_{N} is configured to process items selected by customers for purchase and to process payment for such items. Some retail enterprises may include a single brick and mortar outlet, and other larger enterprises may include two or more physically remote brick and mortar outlets. In the latter case, the retail enterprise may include, for example, a main physical location with two or more remote physical locations, and for purposes of this document the two or remote physical locations in such an arrangement are referred to as “hub” locations. In this disclosure, the system 10 will be illustrated and described in the context of such a larger retail enterprise having a main physical location and two or more physical hub locations. In this regard, the main server 12 in the system 10 shown in FIG. 1 will typically be located at a main business location of the retail enterprise, and will be coupled via the network 20 to two or more local hub servers 22₁-22_{L}, each of which will typically be located at a different one of the two or more hub locations.

Each hub location may include any number of point-of-sale systems coupled to a corresponding local hub server, and in the embodiment illustrated in FIG. 1, for example, the local hub server 22₁ is communicatively coupled to “M” such point-of-sale systems 24₁-24_{M}, where M may be any positive integer, and the local hub server 22_{K} is communicatively coupled to “N” such point-of-sale systems 24₁-24_{N}, where N may be any positive integer and where M may or may not be equal to N. Communicative coupling between the local hub server 22₁ and the one or more point-of-sale systems 24₁-24_{M}, and between the local hub server 22_{L} and the one or more point-of-sale systems 22₁-22_{N}, may be accomplished using any known communication coupling, and communications over any such hardwire and/or wireless coupling may be accomplished using any known communication protocol.

In some alternative embodiments of such a large retail enterprise, one or more of the local hub servers 22₁-22_{L} may be omitted, and the main server 12 may be coupled directly, via the network 20, to one or more point-of-sale systems 24₁-24_{M}, 24₁-24_{N}, or the main server 12 may be omitted and at least one of the local hub servers 22₁-22_{L} may be configured to act as a so-called master server with the remaining local hub servers 22₁-22_{L} configured to act as so-called slave servers. In other alternative embodiments in which the retail enterprise includes only a single brick and mortar outlet, the local hub servers 22₁-22_{L} may be or include the main server 12 or vice versa. For purposes of the following description, any process disclosed as being controlled by the main server 12 may, in some embodiments, instead be controlled, in whole or in part, by one or more local hub servers 22₁-22_{L} and vice versa, and/or may be controlled, in whole or in part, by one of the point-of-sale systems 24₁-24_{M}, 24₁-24_{N} and vice versa.

The local hub server 22₁ may be embodied as any type of server (e.g., a web server) or similar computing device capable of performing the functions described herein. In the illustrative embodiment of FIG. 1, the local hub server 22₁ includes a processor 30, an I/O subsystem 32, a memory 34, a data storage 36, a communication circuitry 38, and one or more peripheral devices 40. It should be appreciated that the local hub server 22₁ may include other components, sub-components, and devices commonly found in a sever and/or computing device, which are not illustrated in FIG. 1 for clarity of the description.

The processor 30 of the local hub server 22₁ may be embodied as any type of processor capable of executing software/firmware, such as a microprocessor, digital signal processor, microcontroller, or the like. The processor 30 may be a single processor or include multiple processors. The I/O subsystem 32 of the local hub server 22₁ may be embodied as circuitry and/or components to facilitate input/output operations with the processor 30 and/or other components of the local hub server 22₁. The processor 30 is communicatively coupled to the I/O subsystem 32.

The memory 34 of the user local hub server 104 may be embodied as or otherwise include one or more conventional volatile and/or non-volatile memory devices. The memory 34 is communicatively coupled to the I/O subsystem 32 via a number of signal paths. Although only a single memory device 34 is illustrated in FIG. 1, the local hub server 22₁ may include additional memory devices in other embodiments. Various data and software may be stored in the memory 34. The data storage 36 is also communicatively coupled to the I/O subsystem 32 via a number of signal paths, and may be embodied as any type of device or devices configured for the short-term or long-term storage of data such as, for example, memory devices and circuits, memory cards, hard disk drives, solid-state drives, or other data storage devices.

The communication circuitry 38 of the local hub server 22₁ may include any number of devices and circuitry for enabling communications between the local hub sever 22₁ and the main server 12 and between the local hub server 22₁ and the one or more point-of-sale systems 24₁-24_{M}. In the illustrated embodiment, for example, communication between the local hub server 22₁ and the main server 12 takes place wirelessly via the network 20, wherein the network 20 may represent, for example, a private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the local hub server 22₁ and the main server 12 may be a non-private network and/or may be, in whole or in part, a wired connection. Generally, the communication circuitry 38 may be configured to use any one or more, or combination, of conventional secure and/or unsecure communication protocols to communicate with the main server 12. As such, the network 20 may include any number of additional devices, such as additional computers, routers, and switches, to facilitate communications between the local hub server 22₁ and the main server 12. Communication between the local hub server 22₁ and the one or more point-of-sale systems 24₁-24_{M}, 24₁-24_{N} may take place via one or more such wireless communication interfaces and/or via one or more conventional wired interfaces.

In some embodiments, the local hub server 22₁ may also include one or more peripheral devices 40. Such peripheral devices 40 may include any number of additional input/output devices, interface devices, and/or other peripheral devices. For example, the peripheral devices 40 may include a display, a keyboard, a mouse, audio processing circuitry, and/or other input/output devices.

The local hub server 22_{L} may be substantially similar to the local hub server 22₁ and include similar components. As such, the description provided above of the components of the local hub server 22₁ may be equally applicable to such similar components of the local hub server 22_{L} and are not repeated herein so as not to obscure the present disclosure. Of course, it should be appreciated that in some embodiments one or more of the local hub servers 22₁-22_{L} and may be dissimilar to others of the local hub servers 22₁-22_{L}.

An embodiment of the main server 12 is also illustrated in FIG. 1, and generally includes the same components as the local hub server 22₁. For example, a processor 50 is coupled to an I/O subsystem 52, and the I/O subsystem 52 is coupled to a memory 54, a data storage unit 56, communication circuitry 58 and one or more peripheral devices 60. In some embodiments, each of the foregoing components may be identical to corresponding components of the local hub server 22₁ described above, and a detailed explanation of such components will not be repeated here for brevity. In other embodiments, the main server 12 may be configured differently than the local hub server 22₁ described above. In any case, the communication circuitry 38 of each of the local hub servers 22₁-22_{L} facilitates communication with the communication circuitry 58 of the main server 12 and vice versa so that information can be shared between the main server 12 and each of the one or more local hub servers 22₁-22_{L} via the network 20. Although only one such main server 12 is shown in FIG. 1, it should be appreciated that, in other embodiments, the system 10 may include any number of shopper main servers, and in still other embodiments the main server 12 may be communicatively coupled to one or more remote serves 26 of the retail enterprise as shown by dashed-line representation in FIG. 1. In such embodiments, the one or more remote servers may include any structure or feature illustrated and described herein with respect to the main server 12, and may be configured to execute any one or more functions described with respect to the main server 12 either alternatively to the main server 12 or in addition to the main server 12. In any case, the main server 12 may be embodied as any type of server (e.g., a web server) or similar computing device capable of performing the functions described herein.

The mobile communication devices 16₁-16_{J} illustrated in FIG. 1 are intended to depict mobile communication devices that are each separately owned and/or operated by a different shopper. No limit on the total number of such mobile communication devices 16₁-16_{J} that may be owned and operated by any one shopper, or on the total number of such mobile communication devices 16₁-16_{J} that may communicate with the main server 12, is intended or should be inferred. The mobile communication devices 16₁-16_{J} may be or include any mobile electronic device capable of executing one or more software application programs and of communicating with the main server 12 via the public network 14. Examples of the mobile communication devices 16₁-16_{J} include, but should not be limited to, mobile telephones, smart phones, tablet computers, personal data assistants (PDAs), and the like.

The user computing devices 18₁-18_{L} illustrated in FIG. 1 are intended to include any of privately owned and accessed computers, such as those residing in shopper's residences, to include semi-privately owned and accessed computers, such as those residing at multiple-employee business enterprises, and publicly accessible computers, such as those available at internet cafés and kiosks. The user computing devices 18₁-18_{L} may be or include any computer capable of executing one or more software programs and of communicating with the main server 12 via the public network 14. Examples of the user computing devices 18₁-18_{L} include, but should not be limited to, personal computers (PCs), laptop computers, notebook computers and the like, whether or not networked with one or more other computing devices.

Referring now to FIG. 2, an embodiment 24 of one of the one or more point-of-sale systems, 24₁-24_{M}, 24₁-24_{N}, is shown which includes components similar to the main server 12 and also to the one or more local hub servers 22₁-22_{L}, such as a processor 200, an I/O subsystem 204, a memory 202, a data storage device 206, communication circuitry 210 and a number of peripheral devices 212. In some embodiments, each of the foregoing components may be identical to corresponding components of the local hub server 22₁ described above, and a detailed explanation of such components will not be repeated here for brevity. In other embodiments, any of the one or more point-of-sale systems 24₁-24_{M}, 24₁-24_{N} may be configured differently than the local hub server 22₁ described above. In the illustrated embodiment, the memory 202 illustratively includes an EMS module 208 in the form of, e.g., instructions executable by the processor 200, to communicate customer-member information to and from the main server 12, and to control one or more local peripheral devices to facilitate communications between customer-members of the enterprise membership services and the main server 12 and to facilitate customer input of customer-identifying information, e.g., an EMS identifying number and/or code (EMSID).

Additionally, the illustrated point-of-sale system 24 includes one or more actuators 226 and hardware infrastructure 228, examples of which will be described below. It will be appreciated that the point-of-sale system 24 may include other components, sub-components, and devices commonly found in a computer and/or computing device. In any case, the communication circuitry 210 is configured to facilitate communication with a corresponding one of the local hub servers 22₁-22_{L} and the point-of-sale system 24 may use any suitable communication protocol to communicate with the corresponding local hub server 22₁-22_{L}.

In addition to, or alternatively to, the number of peripheral devices 40 of the local hub server 22₁ described above, the number of peripheral devices 212 of the point-of-sale system 24 may include any number of other peripheral or interface devices. Examples of some of the peripheral devices 212 illustrated in FIG. 2 include, but should not be limited to, one or more conventional payment interfaces 214, one or more conventional item price scanners 216, one or more conventional display monitors 218, one or more conventional produce scales 220 and one or more conventional controllers 224 for controlling one or more conventional actuators 226 associated with the operation of the point-of-sale system 24. The one or more payment interfaces 214 are provided, e.g., to facilitate receipt of credit/debit card and/or other form of payment from customers (shoppers), and each such interface 214 may illustratively include one or more of a display, a touch screen, a keyboard, a mouse, external speakers, and/or other peripheral devices. One or more of the payment interfaces 214 may further include a produce scale 220, and one or more produce scales 220 may alternatively be coupled to the point-of-sale system 24 separately from the one or more customer payment interfaces 214. The one or more item scanner(s) 216 is/are configured to scan price code labels or other such indicators for items being purchased by customers and to also scan print media coupons.

The one or more display monitor(s) 218 provide item and/or pricing information to customers and/or enterprise employees, and may further provide additional information regarding cost and/or discounts for one or more items being purchased as well as information regarding discounts realized by customers through the use of print media and/or virtual coupons. The display monitor(s) 218 may additionally provide an interface, e.g., touchscreen or a co-located keypad, via which customers may input information such as their EMSID. The peripheral devices 212 of the point-of-sale system 110 may further optionally include a near-field communication device 222, as illustrated in dashed-line configuration in FIG. 2, which may be included in embodiments in which one or more of the mobile communication devices 16₁-16_{J} also has such a near-field communication device such that customer information, e.g., customer identification information such as EMSIDs, user names, passwords, or the like, can be transferred from such one or more of the mobile communication devices 16₁-16_{J} to the point-of-sale system 24 by tapping the two near-field communication devices together or by passing the near-field communication device of a so-equipped mobile communication device 16₁-16_{J} sufficiently close to the near-field communication device 222 to effectuate such communication. In other embodiments, customers can transfer customer identification information to the point-of-sale system 24 via the payment interface 214, item scanner 216 or other peripheral device(s).

The point-of-sale system 24 further includes hardware infrastructure 228 which forms the structural backbone of the point-of-sale system 24. Examples of structural components that may be included in the hardware infrastructure 228 include, but should not be limited to, one or more purchased item transport units, e.g., one or more purchased item conveyance units or systems, one or more conventional purchased item bagging areas, e.g., one or more conventional item bagging carousals, one or more purchased item support units, and the like. The one or more actuators 226 may be or include any actuator that is controllable by at least one of the one or more conventional controllers 224, and which may facilitate operation and/or control of the hardware infrastructure of the point-of-sale system 24. Examples of such one or more actuators may include, but should not be limited to, one or more linear and/or rotational drive motors, one or more electronically controlled switches, and the like.

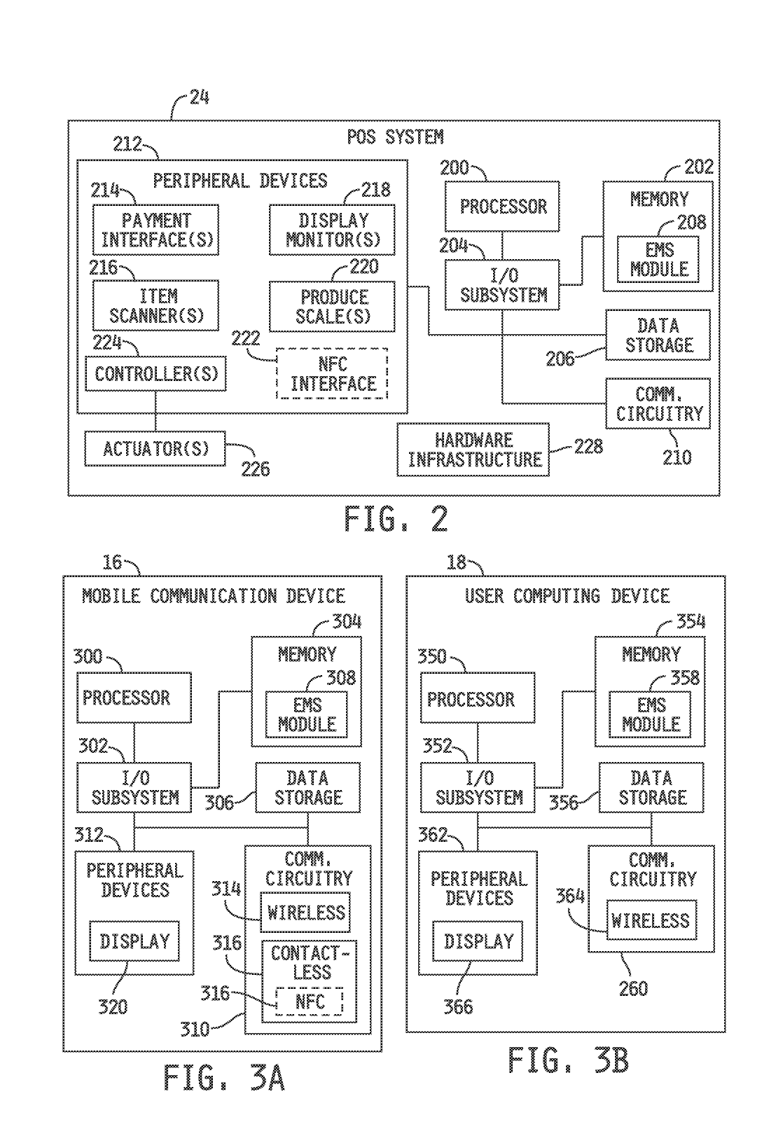

Referring now to FIG. 3A, an embodiment of one of the mobile communication devices 16 illustrated in FIG. 1 is shown, which includes components similar to the main server 12 and also to the one or more local hub servers 22₁-22_{L} and the one or more POS systems 24₁-24_{M}, 24₁-24_{N}, such as a processor 300, an I/O subsystem 302, a memory 304 including an EMS module 308, a data storage device 306, communication circuitry 310 and a number of peripheral devices 312. In some embodiments, each of the foregoing components may be identical to corresponding components of the local hub server 22₁ and/or POS system 24 described above, and a detailed explanation of such components will not be repeated here for brevity. In other embodiments, any of the one or more mobile communication devices 16₁-16_{J} may be configured differently than the local hub server 22₁ described above. It will be appreciated that the mobile communication device 16 may include other components, sub-components, and devices commonly found in a computer and/or computing device. In any case, the communication circuitry 310 illustratively includes conventional wireless communication circuitry 314 configured to facilitate communication with the main server 12 via the network 14, and the mobile communication device 16 may use any suitable communication protocol to communicate with the corresponding main server 12. The communication circuitry 310 of the mobile communication device 16 may further optionally include conventional contact-less communication circuitry 316, which may include a conventional near-field communication device 318, as illustrated by dashed-line representation in FIG. 3A. The near-field communication device 318 may be included, for example, in embodiments in which one or more of the point-of-sale systems 24₁-24_{M}, 24₁-24_{N} also has/have such a near-field communication device 222 such that customer information, e.g., customer identification information in the form of one or more identification codes (e.g., EMSID), user names, passwords, or the like, can be transferred from the mobile communication device 16 to such one or more point-of-sale systems 24₁-24_{M}, 24₁-24_{N} by tapping the two near-field communication devices together or by passing the near-field communication device of the mobile communication device 16 sufficiently close to the near-field communication device 222 to effectuate such communication. In addition to, or alternatively to, the number of peripheral devices 40 of the local hub server 22₁ described above, the number of peripheral devices 312 of the mobile communication device 16 may include any number of other or additional peripheral or interface devices. One example of such an additional peripheral device illustrated in FIG. 3A includes, but should not be limited to, a conventional visual display unit 320.

Referring now to FIG. 3B, an embodiment of one of the user computing devices 18 illustrated in FIG. 1 is shown, which includes components similar to the shopper reward server 12 and also to the one or more local hub servers 22₁-22_{L} and the one or more POS systems 24₁-24_{M}, 24₁-24_{N}, such as a processor 350, an I/O subsystem 352, a memory 354 including an EMS module 358, a data storage device 356, communication circuitry 360 and a number of peripheral devices 366. In some embodiments, each of the foregoing components may be identical to corresponding components of the local hub server 22₁ and/or POS system 24 described above, and a detailed explanation of such components will not be repeated here for brevity. In other embodiments, any of the one or more user computing devices 18₁-18_{K} may be configured differently than the local hub server 22₁ described above. It will be appreciated that the user computing device 18 may include other components, sub-components, and devices commonly found in a computer and/or computing device. In any case, the communication circuitry 360 illustratively includes conventional wireless communication circuitry 364 configured to facilitate communication with the main server 12 via the network 14, and the user computing device 18 may use any suitable communication protocol to communicate with the corresponding main server 12. In addition to, or alternatively to, the number of peripheral devices 40 of the local hub server 22₁ described above, the number of peripheral devices 366 of the user computing device 18 may include any number of other or additional peripheral or interface devices. One example of such an additional peripheral device illustrated in FIG. 3B includes, but should not be limited to, a conventional visual display unit 366.

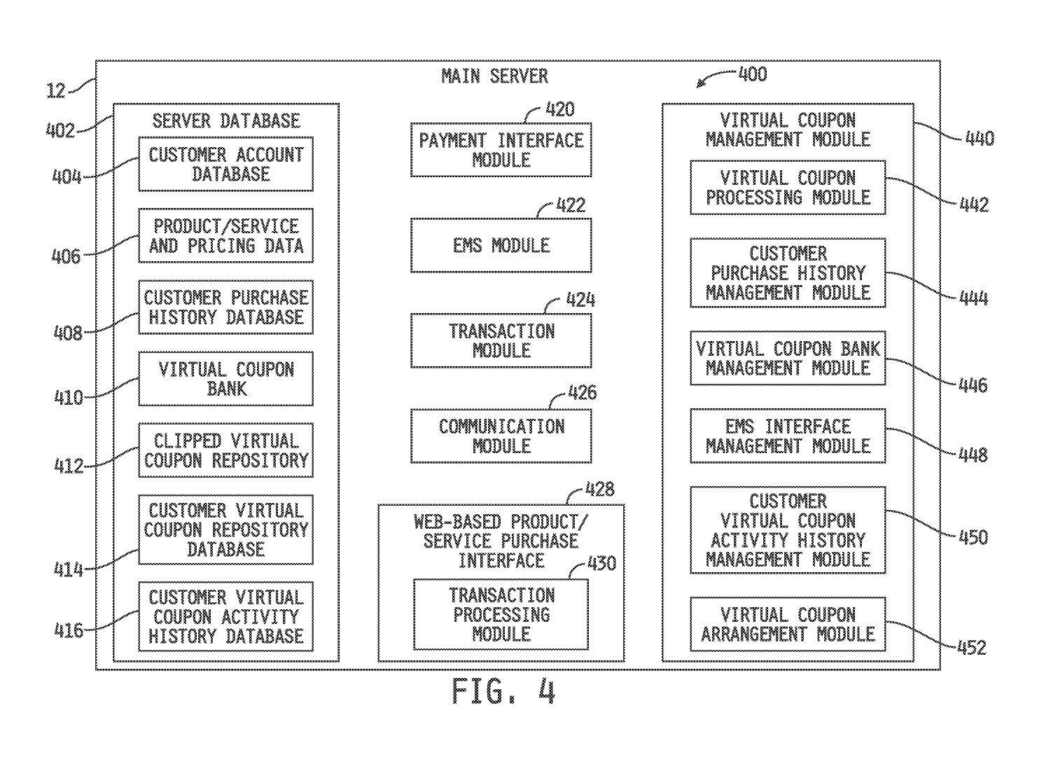

Referring now to FIG. 4, a simplified block diagram is shown of an embodiment of an environment 400 of the main server 12 illustrated in FIG. 1. In the illustrated embodiment, the environment 400 includes a server database 402 which includes customer account database 404, product/service and pricing data 406, a customer purchase history database 408, a virtual coupon bank 410, a clipped virtual coupon repository 412, a customer virtual coupon repository 414 and a customer virtual coupon activity history database 416.

The main server 12 provides, stores and manages virtual discount coupons for one or more shoppers. Shoppers may elect to participate in an enterprise membership services (EMS) program by establishing a user account within the server 12, which user account may in some cases be an individual account accessible only by an individual person, e.g., an individual shopper, and in other cases may be a group or “household” account accessible by each of a plurality of members of a predefined group of persons, e.g., members of a family or household, one or more employees of a business enterprise, etc. The terms “shopper,” “member,” “shopper member,” “customer” and “household,” and variants thereof, are used interchangeably in the following description, and such terms should be understood to refer interchangeably to an individual shopper or a predefined group of individual shoppers (referred to herein as a “household”) who shop at and purchase items from a retail enterprise, and who are active members of an enterprise membership service of the type described herein and provided and managed by the retail enterprise.

Illustratively, a software application program is available for download from the main server 12 via the public network 14 for shoppers electing to access the EMS program via their mobile communication device, e.g., one of the mobile communication devices 16₁-16_{J}. Once downloaded and activated, shoppers can access and manage their EMS program account and program features, such as viewing, managing and clipping virtual discount coupons, via the software application program executed by their mobile communication device 16₁-16_{J}. The shopper reward server 12 alternatively or additionally hosts and controls an EMS website accessible via the public network 14, and in such embodiments shoppers can access and manage their EMS account and program features, such as viewing, managing and clipping virtual discount coupons, by accessing the main server 12 via a computing device 18₁-18_{L} and/or via their mobile communication device 16₁-16_{J} if the latter is equipped with a web browser.

In the illustrated embodiment, the customer account data 404 of the server database 402 has stored therein information relating to user accounts and profile data for each of the members of the EMS program. As shoppers join the EMS program, the server 12 assigns corresponding enterprise membership services identification (EMSID) and such EMSID and other profile information entered into the server 12 is stored along with the EMSID information in the customer account data 404. The EMSID illustratively includes or identifies a purchase tracking identifier code. The purchase tracking identifier code may be or include, for example, one or more of a shoppers ID card, an ID associated with an RFID tag, which RFID tag may be part of the NFC communication circuitry of the mobile communication device 16₁, a shopper's incentive card, or the like. Members of the EMS program described herein will typically scan or otherwise communicate or enter via a keypad at least one of the above-described purchase tracking identifier code items with one of the point-of-sale terminals 24₁-24_{M} (or 24₁-24_{N}), and it is through such a purchase tracking identifier code that the main server 12 will monitor and track purchases made by member shoppers from the retail enterprise during purchase transactions, and make available to the member shoppers the various EMS benefits described herein. All such purchase transaction data relating to items purchased by shoppers during purchase transactions carried out via one or more purchase interfaces is stored in the customer purchase history database 408. Illustratively, the purchase transaction data includes, but is not limited to, product/service identification information, product/service pricing, and the like.

As part of the EMS program described herein, the main server 12 provides discount offers to member shoppers for one or more items purchasable from the business enterprise, e.g., in the form of one or more corresponding virtual discount coupons. In this regard, each member shopper is provided by the main server 12 with access to dedicated portion of a customer virtual coupon repository database 414 in which virtual discount coupons specific to the member shopper or customer are stored and via which the member shopper may access and redeem one or more virtual discount coupons. In one embodiment, the server database 402 includes a plurality of customer virtual coupon repositories; one for each of the plurality of member shoppers. Alternatively, the server database 402 may include a single repository 414, and each member shopper of the EMS program is provided with access to a dedicated portion of the repository 414; i.e., which can be accessed by one shopper to the exclusion of all other shopper members. The server database 402 further illustratively includes a clipped virtual coupon repository 412 in which virtual discount coupons “clipped” by shopper members, i.e., selected for redemption, are stored. The server database 402 may include a single such repository 412, and each member shopper of the EMS program may be provided with access to a dedicated portion of the repository 412; i.e., which can be accessed by one shopper to the exclusion of all other shopper members, or a separate repository 412 for each member shopper.

When a member shopper enters the member shopper's EMSID into a purchase interface, e.g., into a point-of-sale system 24₁-24_{M}, 24₁-24_{N}, the processor 200 of the point-of-sale system 24₁-24_{M}, 24₁-24_{N} identifies the shopper and associates that shopper with the current purchase transaction being carried out at the point-of-sale system 24₁-24_{M}, 24₁-24_{N}. The point-of-sale system 24₁-24_{M}, 24₁-24_{N}, which is communicatively coupled to the main server 12 via a local hub server 22₁-22_{L}, can then access virtual discount coupons resident within that customer's clipped virtual coupon repository 412, and can thus redeem any such virtual discount coupon in the shopper's clipped virtual coupon repository 412 against a corresponding item being purchased by the member shopper in a purchase transaction. MPERKS®, a virtual customer coupon collection and redemption program offered to customers by Meijer, Inc. of Grand Rapids, Mich., is an example of one such virtual discount coupon storage and redemption platform that may be used with the EMS program described herein, although it will be appreciated that any virtual customer coupon service which makes available to customers virtual customer coupon repositories in which virtual coupons can be stored and redeemed by customers during item purchase transactions at point-of-sale systems or terminals or web-based purchase interfaces may be alternatively be used.

The product/service and pricing data 412 contains information relating to the retail products and services sold by the retail enterprise which the shopper reward server 12 serves, which information includes product pricing information. Illustratively, product/service pricing information is linked to product/service identification information via scan codes such that when items are scanned for purchase, the scan code of each item will identify a particular item at a particular price in the product/service and pricing database 412. The information stored in the product/service and pricing database 412 may further include any one or more of current product inventory information, product/service location within the corresponding retail outlet, past, current and future service usage and cost, past, current and future product cost and ordering information, product and service identification information, past, current and future product and service discount information, and the like.

The virtual coupon bank 410 has stored therein virtual discount coupons that are received from an external source and from which the customer virtual coupon repositories 414 may be populated, e.g., periodically, aperiodically and/or on an ad hoc basis. The server database 402 further includes a customer virtual coupon activity history database 416 which has stored therein virtual coupon activity of each shopper member, including handling by each shopper member of virtual discount coupons within that shopper member's virtual coupon repository.

The environment 400 of the shopper reward server 12 further includes a payment interface module 420, an EMS module 422, a transaction module 424, a communication module 426 and a virtual point-of-sale environment in the form of a web-based product/service purchase interface 428. The payment interface module 420 is configured, in a conventional manner, to process electronic forms of customer payment, e.g., credit card, debit card, etc., used at the point-of-sale systems 24₁-24_{M}, 24₁-24_{N}. The EMS module 422 is configured to manage EMS-related activity, some of which is described herein. The communication module 426 is configured, in a conventional manner, to control and manage all communications between the shopper reward server 12 and the local hub servers 22₁-22_{L} in embodiments that include the local hub servers 22₁-22_{L}, and to control and manage all communications between the shopper reward server 12 and all point-of-sale systems 24₁-24_{M}, 24₁-24_{N} in embodiments that do not include a local hub server 22₁-22_{L}.

The web-based product/service purchase interface 428 includes a transaction processing module 430 configured, in a conventional manner, to process the sale of items, e.g., products and/or services, via a web-based store or catalog (i.e., Internet-accessible web-site hosted by the server 12 of the business enterprise) by allowing customers to select items for purchase and by processing electronic forms of customer payment.

The customer payment interface 214 and item scanner 216 of the point-of-sale system 24, together with the payment interface module 420 and product scan interface module 422 of the main server 12, make up one type of customer-accessible product purchase interface in the form of a point-of-sale terminal physically located at a brick-and-mortar location of the business enterprise. The web-based product/service purchase interface 428 makes up another type of customer-accessible product purchase interface in the form of a virtual point-of-sale environment that is accessible by customers via the Internet. In any case, the communication module 426 is configured, in a conventional manner, to control and manage all communications between the shopper reward server 12 and the local hub servers 22₁-22_{L} via the network 20, and to control and manage all communications between the main server 12 and the mobile communication devices 16₁-16_{J} and between the main server 12 and the user computing devices 18₁-18_{K} via the network 14.

The transaction module 426 is configured to monitor purchases of products and services made by shopper members of the EMS program using any of the purchase interfaces, e.g., any of the point-of-sale systems 24₁-24_{M}, 24₁-24_{N}, and/or the web-based product/service purchase interface 428, and to store purchase transaction data associated with such purchases in the customer purchase history database 408. Illustratively, the customer purchase history database 408 is partitioned or otherwise configured to store such purchase transaction data in a manner that provides for the separate tracking and identification of at least a portion of the shopper purchase histories of each shopper (or household) member and further provides for the tracking and identification of at least a portion of the shopper purchase histories of all shopper members. For example, which should not be considered to be limiting in any way, the transaction module 424 is illustratively configured in one embodiment to store the purchase transaction data in the customer purchase history database 408 in a manner that separately identifies and tracks identification and pricing information for each product and service purchased by each shopper, and that identifies and tracks identification and pricing information for each product and service purchased by all shoppers.

The environment 400 of the shopper reward server 12 further includes a virtual coupon management module 440 which includes a virtual coupon processing module 442, a customer purchase history management module 444, a virtual coupon bank management module 446, an EMS interface management module 448, a customer virtual coupon activity history management module 450 and a virtual coupon arrangement module 452, some of which will be described herein. The virtual coupon bank management module 446 is configured to construct and update the virtual coupon bank stored in the virtual coupon bank database 410.

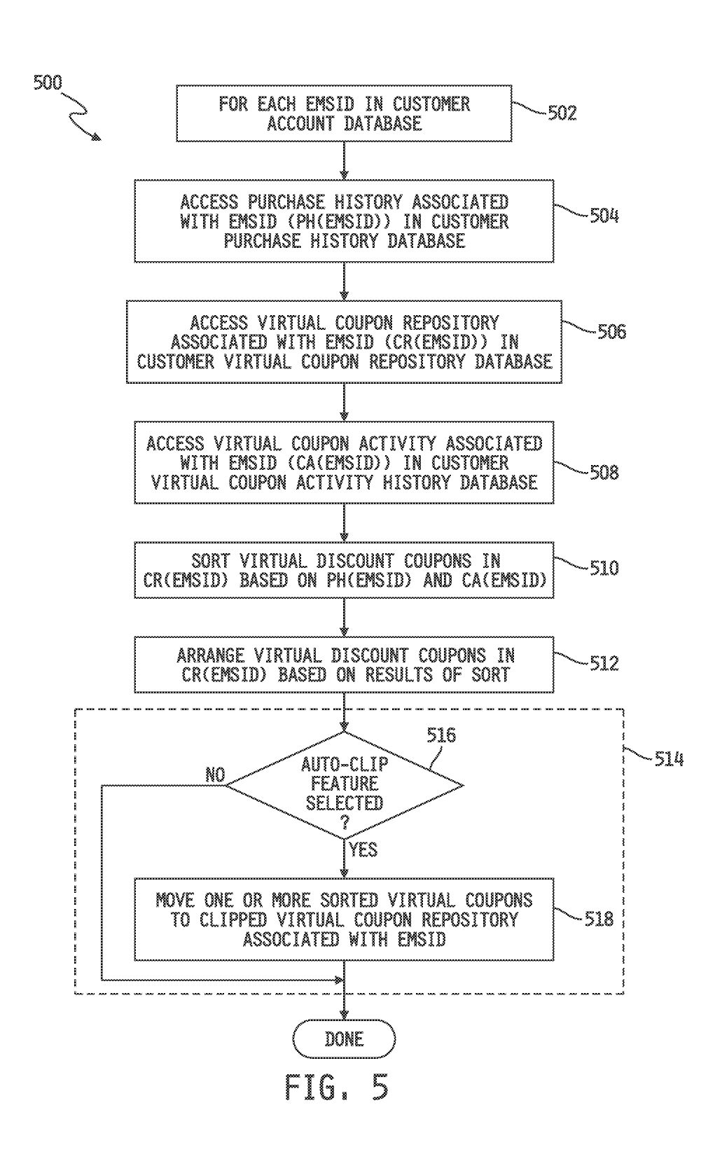

Referring now to FIG. 5, a process 500 is shown for presenting virtual coupons to customers of a retail enterprise based on shopping history. In one embodiment, the process 500 is stored in the memory 54 (and/or data storage 56) of the main server 12 in the form of instructions executable by the processor 50 of the main server 12, and the process steps of the process 500 will be described below for purposes of this disclosure as being executed by the processor 50 of the main server 12. It will be understood, however, that in some alternate embodiments, the process 500 may be alternatively stored, in whole or in part, in the memory 34 (and/or data storage 36) of the one or more of the local servers 22₁-22_{L} in the form of instructions executable, in whole or in part, by the processor 30 of one or more of the local servers 22₁-22_{L}, and in other embodiments the process 500 may be stored, in whole or in part, in the memory 202 (and/or data storage 206) of the one or more of the POS systems 24₁-24_{M}, 24₁-24_{N} in the form of instructions executable, in whole or in part, by the processor 200 of one or more of the one or more of the POS systems 24₁-24_{M}, 24₁-24_{N}. In any such embodiment, the process 500 may be executed in whole or in part by one or more processors within any one or a combination of the main server 12, any of the one or more local servers 22₁-22_{L} and any of the one or more of the POS systems 24₁-24_{M}, 24₁-24_{N}, wherein information may be shared between the such systems via wired and/or wireless connection.

The process 500 begins at step 502 where the processor 50 begins a loop in which the processor 50 carries out the remaining steps of the process 500 for each individual enterprise membership service customer account, i.e., each EMSID, in the customer account database 404. Illustratively, the process 500 operates separately and sequentially with respect to each enterprise membership service account number, i.e., each EMSID. Alternatively, the process 500 may operate separately on each EMSID in any order or in a random order. In still other embodiments, the process 500 may operate only on those EMSIDs for which customers have joined a sub-membership to receive access to the process 500 or for which customers have otherwise agreed to receipt of the process 500. Illustratively, the process 500 is executed by the processor 50 periodically, e.g., once per day, although this disclosure contemplates that the process 500 may alternatively be periodically carried out more or less frequently. In alternate embodiments, the process 500 may be executed whenever one or more new virtual coupons are added to the virtual coupon bank 410 of the main server database 402. In other alternate embodiments, the process 500 may be executed aperiodically and/or on an ad-hoc basis.

Following step 502, the process 500 advances to step 504 where the processor 50 is operable to access the purchase history associated with the current EMSID (“PH(EMSID)”) in the customer purchase history database 408, i.e., to access the purchase history of the customer(s) associated with the EMSID currently being processed in the process 500. As described above, the purchase history for each EMSID contained in the customer purchase history database 408 identifies all items previously purchased by the customer from the retail enterprise and linked to the customer's EMSID, e.g., by entering the customer's EMSID into a payment interface 214 at the time of purchase or by post-purchase linking the purchased items to the customer's EMSID. In any case, the purchase history PH(EMSID) accessed at step 504 during any iteration of the process 500 identifies some number of items previously purchased by the corresponding customer from the retail enterprise.

Following step 504, the process 500 advances to step 506 where the processor 50 is operable to access the virtual coupon repository associated with the current EMSID (“CR(EMSID)”) in the customer virtual coupon repository database 414, i.e., to access the virtual coupon repository of the customer(s) associated with the EMSID currently being processed in the process 500. As described above, each virtual coupon repository, i.e., for each EMSID, in the customer virtual coupon repository database 414 contains at any one time a plurality of virtual discount coupons that have been downloaded thereto by the main server 12 for potential “clipping” by the associated customer for subsequent redemption by the retail enterprise against corresponding items to be purchased by the customer from the retail enterprise. Some virtual coupon repositories may contain more or fewer virtual discount coupons than other virtual coupon repositories depending upon the amount of virtual discount coupon redemption activity during one or more previous purchase transactions. Moreover, some virtual coupon repositories may contain different virtual discount coupons than other virtual coupon repositories as a result of different discount coupons that may be offered to different customers. Further still, the main server 12 may periodically, e.g., daily, modify one or more of the virtual coupon repositories by adding new virtual discount coupons, deleting old, unused and/or expired virtual discount coupons and the like. In any case, the virtual coupon repository (CR(EMSID)) accessed at step 506 during any iteration of the process 500 contains a plurality of virtual discount coupons each redeemable by the retail enterprise against at least one item purchasable from the retail enterprise.

Following step 506, the process 500 advances to step 508 where the processor 50 is operable to access the virtual coupon activity associated with the current EMSID (“CA(EMSID)”) in the customer virtual coupon activity database 416, i.e., to access the virtual coupon activity of the customer(s) associated with the EMSID currently being processed in the process 500. As described above, each virtual coupon activity history, i.e., for each EMSID, in the customer virtual coupon activity history database 416 identifies all virtual discount coupon handling previously executed by the customer within that customer's virtual coupon repository. Each customer may handle or manipulate one or more virtual discount coupons contained within that customer's virtual coupon repository in several different ways that may be monitored and tracked by the customer virtual coupon activity history management module 450. For example, the customer virtual coupon activity history management module 450 may monitor and track, over any previous time period or for the customer's entire previous history, one or any combination of the total number of virtual discount coupons clipped for potential subsequent redemption against a corresponding item purchasable from the retail enterprise, the total number and/or percentage of virtual discount coupons clipped by the customer and subsequently redeemed by the retail enterprise, the total number and/or percentage of virtual discount coupons clipped by the customer but never redeemed by the retail enterprise and/or the frequency and/or pattern of virtual discount coupon clipping by the customer.

In some embodiments, the virtual discount coupons may further be defined, e.g., tagged or otherwise identified, according to coupon categories, e.g., categories of goods and/or services offered by the retail enterprise. Examples of virtual discount coupon categories may include, but are not limited to, grocery, clothing, sporting goods, outdoor, pharmacy, gas/fuel, and the like. It will be appreciated, however, that virtual discount coupons may be alternatively identified according to more, fewer, and/or different coupon categories, and it will be understood that all such categories are contemplated by this disclosure. In any case, the virtual coupon activity history management module 450 may, in some embodiments, monitor and track the total number of virtual discount coupons clipped and/or redeemed by the customer within each category (or one or more categories) of coupons, the frequency or pattern of virtual discount coupon clipping by the customer within one or more coupon categories, and the like.

In some embodiments, the customer may “hide” virtual discount coupons within the customer's virtual coupon repository. Such virtual discount coupons may be, for example, virtual discount coupons for items that the customer does not have any interest in purchasing at that time or at all. Illustratively, virtual discount coupon hiding may be accomplished by deselecting a virtual discount coupon within the virtual coupon repository, to which the processor 50 is responsive to render the deselected virtual discount coupon invisible or partially invisible (e.g., “ghosted”). In any case, the virtual coupon activity history management module 450 may, in some embodiments, monitor and track the total number of virtual discount coupons hidden by the customer, the frequency and/or pattern of virtual discount coupons hidden by the customer, and the like. Alternatively or additionally, the virtual coupon activity history management module 450 may, in some embodiments, monitor and track the total number of virtual discount coupons hidden by the customer in one or more categories of virtual discount coupons, the frequency and/or pattern of virtual discount coupons hidden by the customer in one or more virtual discount coupon categories, and the like.

Those skilled in the art will recognize other handling or manipulations by customers of virtual discount coupons within virtual coupon repositories that may be monitored by the customer virtual coupon activity history management module 450, and it will be understood that this disclosure contemplates the monitoring and tracking of any such other handling or manipulations of virtual discount coupons within the virtual coupon repositories. In any case, the virtual coupon activity CA(EMSID) accessed at step 508 during any iteration of the process 500 identifies historical virtual discount coupon handling by the customer associated with that EMSID within that customer's virtual coupon repository.

Following step 508, the process 500 advances to step 510 where the processor 50 sorts the virtual discount coupons in the virtual coupon repository associated with the current EMSID (CR(EMSID)) based at least on the corresponding purchase history (PH(EMSID)) and, in some embodiments, also based on the corresponding virtual coupon activity (CA(EMSID)).

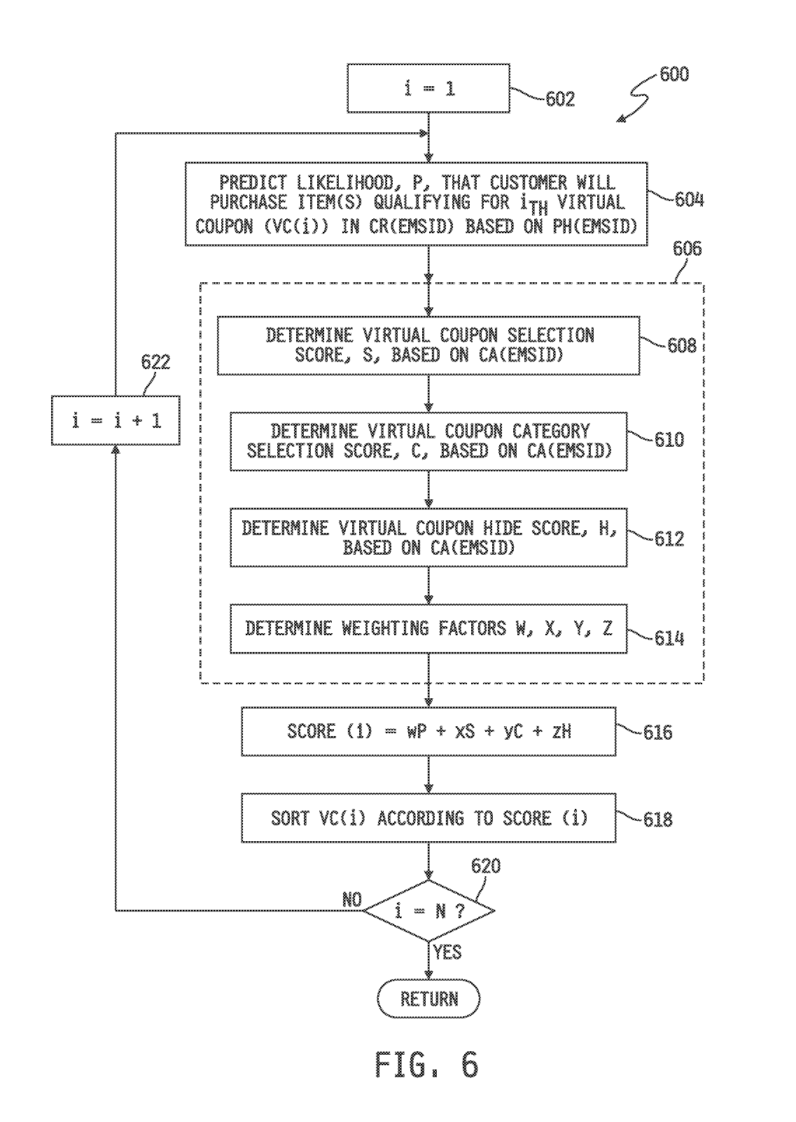

Referring now to FIG. 6, a simplified flow diagram is shown of an embodiment of a process 600 for carrying out step 510 of the process 500 illustrated in FIG. 5. Illustratively, the process 600 is stored in one or more memory and/or data storage devices as described with respect to the process 500 of FIG. 5, and is executed by one or more processors as also described with respect to the process 500. The process 600 illustratively operates to sort virtual discount coupons within the virtual coupon repository associated with the EMSID currently being processed by the process 500 illustrated in FIG. 5. In one embodiment, the process 600 operates to sort all of the plurality of virtual discount coupons contained in the virtual coupon repository CR(EMSID) at the time the process 600 is executed, and in this embodiment the value “N” in step 620 is therefore an integer equal to the total number of virtual discount coupons contained in CR(EMSID). In other embodiments, the process 600 may be configured to sort only a subset of the total number of virtual discount coupons contained in CR(EMSID), and in such embodiments the value “N” in step 620 will be an integer that is less than the total number of virtual discount coupons contained in CR(EMSID).

In any case, the process 600 begins at step 602 where a counter, i, is set to a value of 1. Thereafter at step 604 the processor 50 is operable to predict the likelihood, P, that the customer associated with the EMSID will purchase one or more items that qualify for the ith virtual coupon (VC(i)) in CR(EMSID), i.e., one or more items against which the ith virtual coupon in the customer's virtual coupon repository may be redeemed by the retail enterprise, based on that customer's purchase history, PH(EMSID). In one embodiment, the processor 50 is operable to execute step 604 by computing P using one or more conventional statistical methods. Generally, P will be higher for virtual discount coupons corresponding to items that the customer has purchased before, and will be higher still for virtual discount coupons corresponding to items that the customer routinely purchases. The range of values for P may be arbitrary, and may generally range from any number A to any number B, where A and B may be any real or integer number. In one example embodiment, the values of P may range, from 0 to 100, with 100 being assigned to a virtual discount that corresponds to an item having the highest likelihood of purchase by the customer and 0 being assigned to a virtual discount coupon that corresponds to an item having no likelihood of purchase by the customer. In alternate embodiments, the value of P may range, as in probability theory, from 0 to 1, and other embodiments between −A to +A, where A may be any integer or real number. It will be appreciated that the range of values of P may be or include any desired range, and it will be understood that any such range is contemplated by this disclosure.

In some embodiments, as shown by dashed-line representation in FIG. 6, the process may include a step 606 in which the sorting criteria may further be based on virtual coupon activity associated with the EMSID, or CA(EMSID). It will be understood that step 606 may include any one or combination of the illustrated steps 608-614. In one such step 608, the processor 50 is operable to determine a virtual coupon selection score, S, based on virtual coupon activity associated with the EMSID. In one embodiment, the virtual coupon selection score, S, is a value that is proportional to the total number of virtual coupon repository coupons that were previously clipped by the customer associated with the EMSID within the virtual coupon repository CR(EMSID) for subsequent redemption by the retail enterprise against corresponding items purchased from the retail enterprise. In alternate embodiments, the virtual coupon selection score, S, may be or include one or more other virtual coupon selection activities including, for example, but not limited to the total number and/or percentage of virtual discount coupons clipped by the customer and subsequently redeemed by the retail enterprise, the total number and/or percentage of virtual discount coupons clipped by the customer but never redeemed by the retail enterprise and/or the frequency and/or pattern of virtual discount coupon clipping by the customer. In any case, the range of values of S may, like the prediction value, P, be arbitrary, and may or may not be the same as the range of values of P.

In another step 610 which may be, or be included in, step 606, the processor 50 is operable to determine a virtual coupon category score, C, based on virtual coupon activity associated with the EMSID. In one embodiment, the virtual coupon category selection score, C, is a value that is proportional to the total number of virtual discount coupons within a coupon category of the virtual coupon repository CR(EMSID) shared by (i.e., that is the same as) the virtual discount coupon currently being processed by the process 600, i.e., VC(i), that were previously clipped by the customer associated with the EMSID within the virtual coupon repository CR(EMSID) for subsequent redemption by the retail enterprise against corresponding items purchased from the retail enterprise. In alternate embodiments, the virtual coupon category selection score, C, may be or include one or more other virtual coupon selection activities including, for example, but not limited to the frequency or pattern of virtual discount coupon clipping by the customer within the same category as that of VC(i), or the like. In any case, the range of values of C may, like the prediction value, P, and the virtual coupon selection score, S, be arbitrary, and may or may not be the same as the range of values of P and/or of S.

In another step 612 which may be, or be included in, step 606, the processor 50 is operable to determine a virtual coupon hide score, H, based on virtual coupon activity associated with the EMSID. In one embodiment, the virtual coupon hide score, H, is a value that is proportional to the total number of virtual discount coupons previously hidden by the customer within the virtual coupon repository CR(EMSID). In alternate embodiments, the virtual coupon hide score, H, may be or include one or more other virtual coupon selection activities including, for example, but not limited to the frequency and/or pattern of virtual discount coupons hidden by the customer, the total number of virtual discount coupons hidden by the customer in the same category as that of VC(i), the frequency and/or pattern of virtual discount coupons hidden by the customer in the same category as that of VC(i), or the like. In any case, the range of values of H may, like the prediction value, P, the virtual coupon selection score, S, and the virtual coupon category selection score, C, be arbitrary, and may or may not be the same as the range of values of P and/or of S and/or of C. In one particular embodiment, for example, the ranges of values of P, S and C are illustratively positive numbers and the range of values of H is negative numbers.

In another step 614 which may be, or be included in, step 606, the processor 50 is operable to determine a number of different weighting factors. Generally, a total of four weighting factors w, x, y and z may be selected at step 614, although it will be understood that the weighting factors selected will be determined by the which of the steps 608, 610, 612, if any, are to be included in the process 600. The weighting factors may each be any desired real number, the values of which may be selected as desired to impart more or less weight to P, S, C and/or H.

Following step 606, in embodiments, that include step 606, the process 600 advances to step 616 where the processor 50 computes a total score, Score(i), for the current virtual discount coupon being processed, VC(i), as a function of w, P, x, S, y, C, z and/or H, depending upon which of S, C and/or H are included, if any, in the process 600. In one example embodiment, none of the steps 608-612 are included in the process 600, and the total score, Score(i) for VC(i) is Score(i)=wP. In another example embodiment, all of the steps 608-612 are included in the process 600, and the total score, Score(i) for VC(i) is Score(i)=wP+xS+yC+zH. Other combinations of P, S, C and H are possible.

It will be understood that while step 616 is illustrated in FIG. 6 as a summation of the products of P, S, C and H and their corresponding weighting factors, the function used at step 616 to compute Score(i) may be any known function of P, S, C and/or H. In any case, the process 600 advances from step 616 to step 618 where the processor 50 sorts the most recent virtual discount coupon VC(i) according to the computed Score(i). Thereafter at step 620, the processor 50 determines whether all N virtual discount coupons have been processed and, if not, the process 600 advances to step 622 where the counter value, i, is incremented by 1 before looping back to step 604. Resulting from the process 600 is the number, N, of virtual discount coupons in the virtual coupon repository (which may be the total number of virtual discount coupons in the virtual coupon repository or a subset thereof) sorted in descending order of composite Score values Score(i), where I=1−N.

Referring again to FIG. 5, the process 500 advances from step 510 to step 512 where the processor 50 is operable to arrange one or more of the virtual discount coupons in the virtual coupon repository based on the result of the sort executed at step 510. In one embodiment, for example, the processor 50 may be operable to execute step 512 by identifying for the customer in the virtual coupon repository at least one of the virtual discount coupons resulting from the sort that has a composite score, Score(i) that is within a predefined range of composite scores. Examples of the predefined range include, but should not be limited to, the top N composite scores, the top X % of composite scores, all of the composite scores, etc., where “top” should be understood to correspond to the highest composite scores. In other embodiments, the processor 50 may be operable to execute step 512 by identifying for the customer in the virtual coupon repository at least one of the virtual discount coupons resulting from the sort that has a composite score, Score(i) greater than a predefined composite score. In embodiments which do not include any of steps 608-610 of the process 600, the processor 50 may be operable to execute step 512 by identifying, for example, at least one of the virtual coupons redeemable by the retail enterprise against an item determined to have a likelihood of purchase, P (or wP) from the retail enterprise by the customer that is greater than a threshold likelihood.

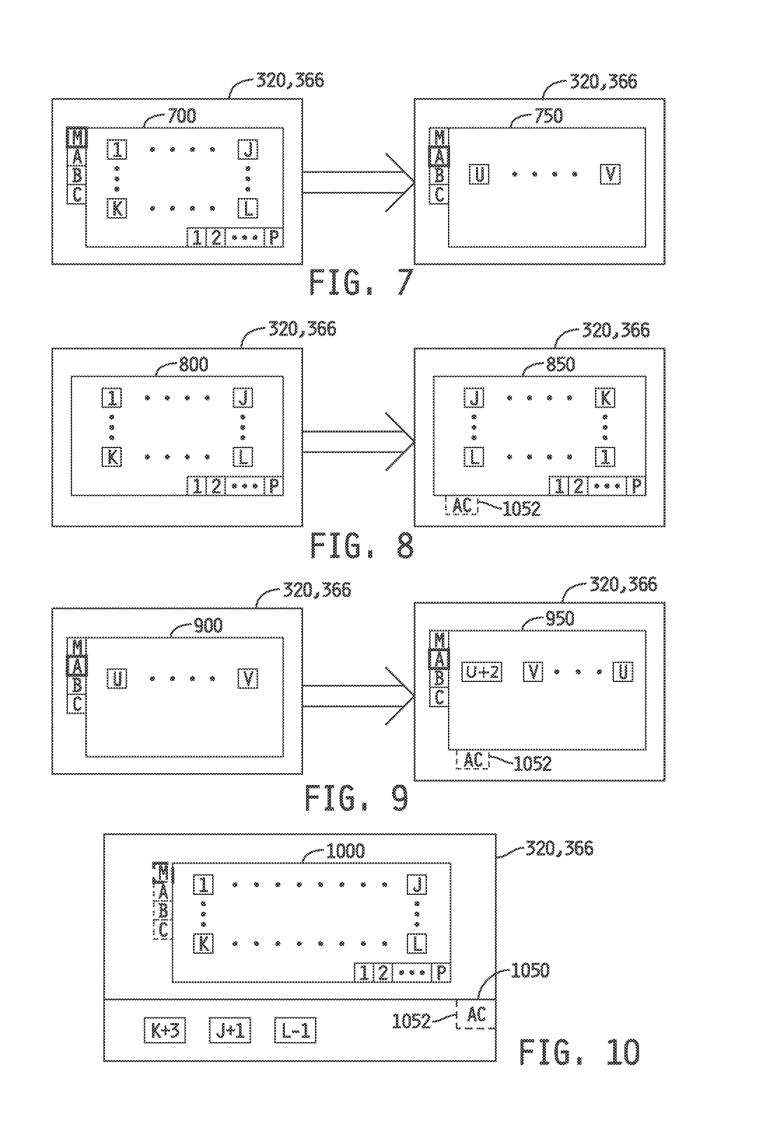

The processor 50 is operable, in any case, at step 512 to arrange one or more of the virtual discount coupons in the virtual coupon repository CR(EMSID) based on the results of the sort executed at step 510. Example arrangements of virtual coupons resulting from the execution of step 512 are illustrated in FIGS. 7-10. Referring to FIG. 7, for example, an example screen shot of the display 320 or display 366 is shown in which a virtual coupon repository 700 includes a main page, M, including images of a number of virtual discount coupons 1-L and having a number of coupon pages 1-P, and a number of coupon category pages A, B, C, with an example virtual coupon repository page 750 shown of the coupon category page A. Referring to FIG. 8, an example screen shot of the display 320 or display 366 is shown in which a virtual coupon repository 800 includes a number of virtual discount coupons 1-L and having a number of coupon pages 1-P prior to execution of the process 500, and an example screen shot the same display 320 or 366 after execution of the process 500 in which the resulting virtual coupon repository 850 is sorted in descending order by the composite score value, Score(i) of each virtual coupon VC(i). In the example illustrated in FIG. 8, virtual discount coupon “J” illustratively has the highest composite score on the displayed page, and the virtual discount coupon “1” illustratively has the lowest composite score on the displayed page.

Referring now to FIG. 9, an example screen shot of the display 320 or display 366 is shown in which a virtual coupon repository category page 900 includes a number of virtual discount coupons U-V prior to execution of the process 500, and an example screen shot the same display 320 or 366 after execution of the process 500 in which the resulting virtual coupon repository 950 is sorted in descending order by the composite score value, Score(i) of each virtual coupon VC(i) on the virtual coupon repository category page 900. In the example illustrated in FIG. 9, virtual discount coupon “U+2” illustratively has the highest composite score on the displayed page 950, and the virtual discount coupon “U” illustratively has the lowest composite score on the displayed page 950.

Referring now to FIG. 10, an example screen shot of the display 320 or display 366 is shown in which a virtual coupon repository 1000 includes a main page, M, including images of a number of virtual discount coupons 1-L and having a number of coupon pages 1-P, and a number of coupon category pages A, B, C. The virtual discount coupons illustrated in the virtual coupon repository 1000 are shown prior to execution of the process 500. Following execution of the process 500, the area 1050 below the virtual coupon repository 1000 shows the top 3 virtual discount coupons resulting from the sort. In the example illustrated in FIG. 10, virtual discount coupon “K+3” illustratively has the highest composite score in the displayed area 1050, followed by the virtual discount coupon “J+1” and then by the virtual discount coupon “L−1.”

Referring again to FIG. 5, the process 500 may further include an additional step 514 in which the a graphic or feature selected within the virtual coupon repository enables an auto-clip feature. For example, the step 514 may include a step 516 in which the processor 50 determines whether the auto-clip feature is selected, e.g., by determining whether the customer has selected this feature in the customer's virtual coupon repository. If so, the process 500 advances to step 518 where the processor 50 automatically moves one or more of the sorted virtual coupons to the clipped virtual coupon repository associated with the EMSID, i.e., to the customer's clipped virtual coupon repository. Thereafter, if the customer purchases items against which any of the auto-clipped virtual discount coupons is redeemable, the retail enterprise, e.g., via one of the point-of-sale systems, will automatically redeem the applicable virtual discount coupons and deduct the discount amounts from the prices of the corresponding purchased items. If, on the other hand, the processor 50 determines at step 516 that the auto-clip feature is not selected, step 518 is not executed.

Referring again to FIGS. 8, 9 and 10, a graphic 1052 is shown on each screen shot which illustratively represents a graphic or selection icon which may be selected or activated by the customer to enable or select the auto-clip feature just described.

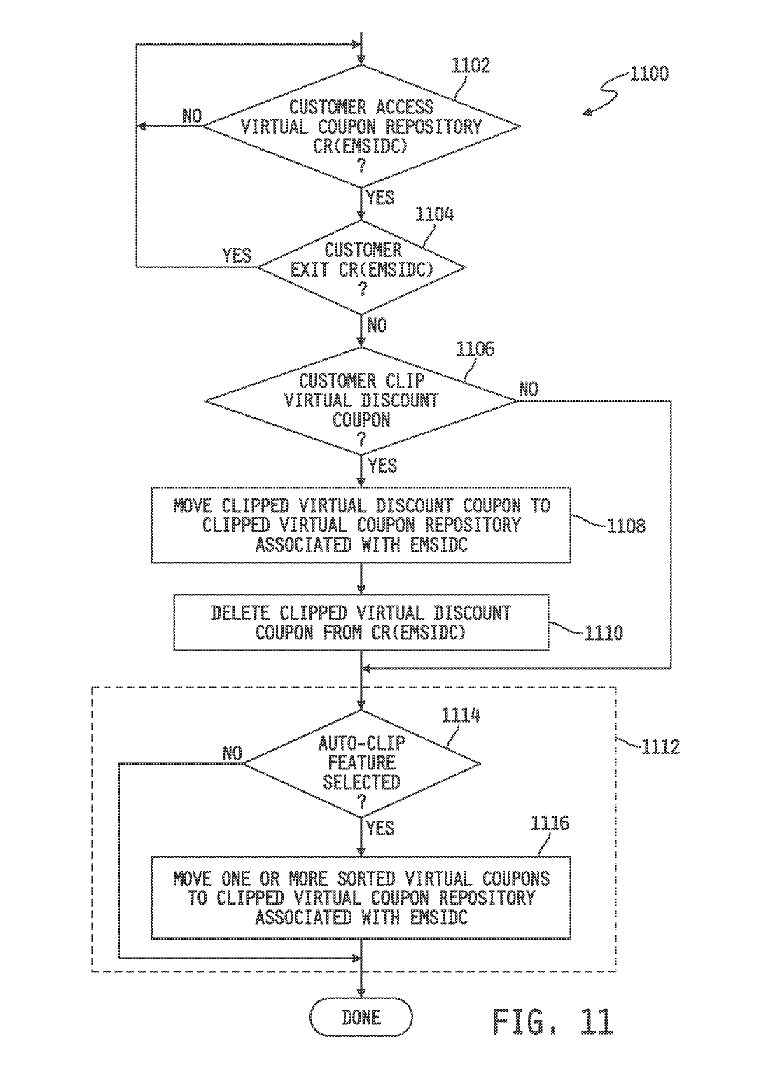

Referring now to FIG. 11, a process 1100 is shown for clipping virtual discount coupons within a virtual coupon repository. The process 1100 is illustratively stored in one or more of the memory devices described with respect to the process 500 of FIG. 5, and is executed by one or more of the processors also described with respect to the process 500. The customer may access the customer's virtual coupon repository using one of the user computing devices 18₁-18_{K} and/or one of the mobile communication devices 16₁-16_{J}. In any case, the process 100 begins at step 1102 where the customer accesses, e.g., via a user computing device or a mobile communication device, the customer's virtual coupon repository CR(EMSIDC). Thereafter at step 1104 the processor 50 determines whether the customer has exited CR(EMSIDC). If not, the processor 50 determines whether the customer has clipped a virtual discount coupon displayed in the customer's virtual coupon repository. If so, the process 1100 advances to step 1108 where the processor 50 is operable to move the clipped virtual discount coupon to the clipped virtual coupon repository associated with EMSIDC, i.e., the customer's clipped virtual coupon repository. Thereafter at step 1110, the processor 50 is operable to delete the clipped virtual discount coupon from CR(EMSIDC).

The process 1100 may further include an additional step 1112 in which a graphic or feature selected within the virtual coupon repository enables the auto-clip feature described above. For example, the step 1112 may include a step 1114 in which the processor 50 determines whether the auto-clip feature is selected, e.g., by determining whether the customer has selected this feature in the customer's virtual coupon repository. If so, the process 500 advances to step 1116 where the processor 50 automatically moves one or more of the sorted virtual coupons to the clipped virtual coupon repository associated with EMSIDC, i.e., to the customer's clipped virtual coupon repository. Thereafter, if the customer purchases items against which any of the auto-clipped virtual discount coupons is redeemable, the retail enterprise, e.g., via one of the point-of-sale systems, will automatically redeem the applicable virtual discount coupons and deduct the discount amounts from the prices of the corresponding purchased items. If, on the other hand, the processor 50 determines at step 1114 that the auto-clip feature is not selected, step 1116 is not executed.

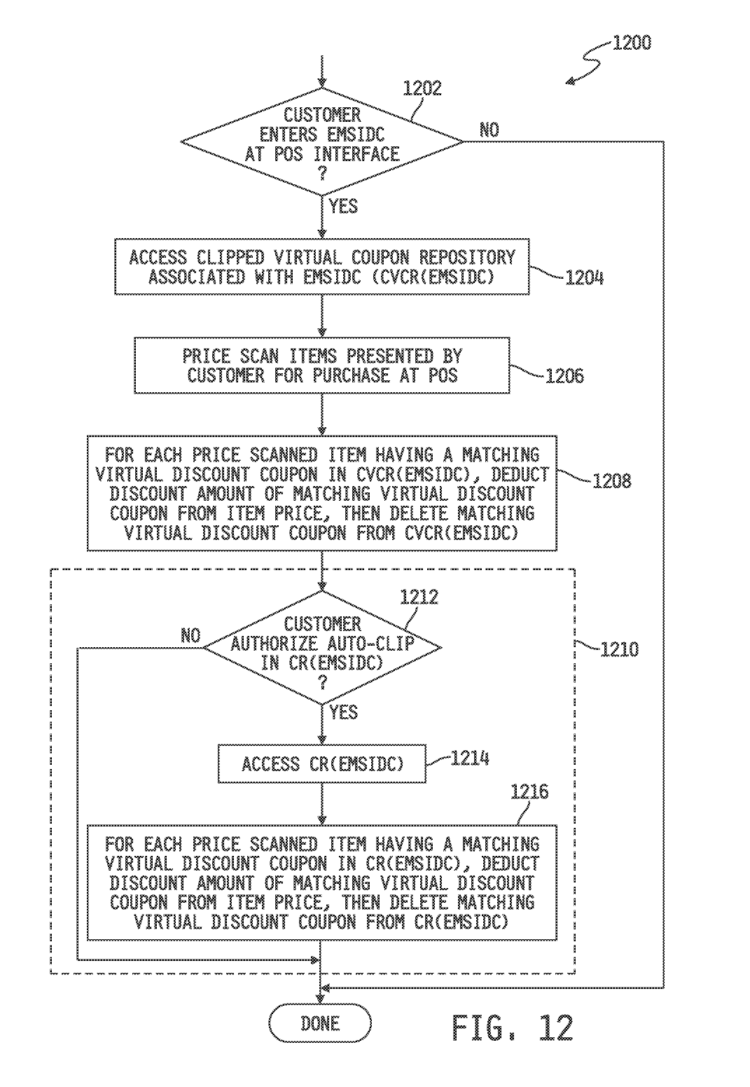

Referring now to FIG. 12, a process 1200 is shown for automatically clipping virtual discount coupons at and by a point-of-sale system that have not been previously clipped in the customer's virtual coupon repository. The process 1100 is illustratively stored in one or more of the memory devices described with respect to the process 500 of FIG. 5, and is executed by one or more of the processors also described with respect to the process 500. The process 1200 begins at step 1202 where the customer enters the customer's EMSID code, i.e., EMSIDC, at a point-of-sale (POS) interface. In one embodiment, the point-of-sale interface may by any of the physical point-of-sale systems 24₁-24_{M}, 24₁-24_{N}. In alternate embodiments, the point-of-sale interface may be or include the web-based product/service purchase interface 428. In any case, after the customer enters the customer's EMSIDC at the POS interface, the process 1200 advances to step 1204 where the processor 50 accessed the clipped virtual coupon repository associated with EMSIDC (CVCR(EMSIDC)), i.e., the customer's clipped virtual coupon repository in which virtual discount coupons clipped by the customer reside. Thereafter at step 1206, the processor 50 controls the point-of-sale interface to price scan, e.g., with a price scanner in the case of the point-of-sale systems 24₁-24_{M}, 24₁-24_{N}, items presented by the customer for purchase at the POS. In embodiments in which the POS interface is the web-based interface 428, prices of the selected items are known and therefore need not be scanned.

Following step 1206, the process 1200 advances to step 1208 where the processor 50 deducts the discount amount of matching virtual discount coupon from the item price for each price scanned item having a matching virtual discount coupon in CVCR(EMSIDC). The processor 50 then illustratively deletes the matching virtual discount coupon from CVCR(EMSIDC).

The process 1200 described thus far may alternatively or additionally include step 1210 which illustratively includes steps 1212, 1214 and 1216. At step 1212 the processor 50 is operable to determine whether the customer has pre-authorized auto-clipping in the customer's virtual coupon repository, i.e., in CR(EMSIDC). One example such pre-authorization for auto-clipping is illustrated in FIGS. 8-10.

Following step 1212, the processor 50 is operable to access CR(EMSIDC), and thereafter at step 1216 the processor 50 is operable to deduct the discount amount of a matching virtual discount coupon from the item price for each price scanned item having a matching virtual discount coupon in CR(EMSID). In one embodiment, the processor 50 may be operable to execute step 1216 by applying the price discounts directly from the virtual discount coupons residing in the virtual coupon repository of the customer (EMSIDC), i.e., without first clipping the virtual discount coupons. In alternate embodiments, the processor 50 may be operable to execute step 1216 by first clipping the applicable virtual discount coupons in the customer's virtual coupon repository so that such virtual discount coupons get moved by the processor 50 to the customer's clipped virtual coupon repository, CVCR(EMSIDC), and then applying the price discounts from the virtual discount coupons residing in the clipped virtual coupon repository. In either case, the processor 50 thereafter illustratively deletes the matching virtual discount coupon from CR(EMSIDC) (and also in CVCR(EMSIDC)).

The foregoing subject matter has been described in the context of processing and arranging one or more of the virtual coupons stored in the various customer virtual coupon repositories 414 of the server database 402 for presentation to, and viewing and/or processing by, customers within such virtual coupon repositories 414 which are illustratively accessible to customer members of an EMS program such as that described herein. In some embodiments, the retail enterprise 5 may alternatively or additionally make available to customers of the EMS program, or other such program, virtual product advertisements which offer to such customers limited time discount pricing on one or more items purchasable from the retail enterprise 5. Such virtual product advertisements may illustratively be stored in the virtual coupon bank 410 or may alternatively be stored in another portion of the database 402 in the form of limited time virtual product advertisements. In one particular embodiments, which is provided only by way of example and should not be considered limiting in any way, such virtual product advertisements may be stored in the virtual coupon bank 410 or other portion of the database 402 in the form of so-called “weekly ads,” which may typically include one or more virtual product advertisements for one or more corresponding items for which a discount pricing is available for a one-week time period. Other time periods for such limited time virtual product advertisements may alternatively or additionally be used.

In some embodiments, such limited time virtual product advertisements may correspond to items purchasable only from a particular one or particular ones of a plurality of retail enterprise outlets or stores controlled by the retail enterprise 5. In some such embodiments, for example, the virtual coupon bank 410 or other portion of the database 402 may be partitioned into plurality of virtual product advertisement repositories each containing a plurality of limited time virtual product advertisements for, and specific to, a different one of the plurality of different retail enterprise outlets or stores controlled by the retail enterprise 5.

In any case, the processor 50 of the main server 12 may alternatively or additional be operable to process such limited time virtual product advertisements similarly as described herein with respect to virtual discount coupons stored in the virtual coupon repository database 414 in order to arrange for viewing and/or processing by customers in the product advertisement bank and/or one or more of the plurality of product advertisement repositories contained in the virtual coupon bank 410 or other portion of the database 402 based on information contained in the customer's purchase history contained in the customer purchase history database 408.

In one embodiment, for example a method for presenting limited time or term product advertisements to customers of the retail enterprise 5 may include accessing with the processor 50 a product advertisement bank, e.g., 410 or other portion of the database 402, wherein the product advertisement bank contains a plurality of virtual product advertisements each identifying limited term discount pricing of at least one item purchasable from at least one of a plurality of retail enterprise outlets controlled by the retail enterprise. The method may further include accessing with the processor 50 a purchase history, e.g., stored in the customer purchase history database 408 and associated in the database 408 with a particular customer, wherein the purchase history identifies items previously purchased by the customer from the retail enterprise as described hereinabove. For each virtual product advertisement in at least a subset of the plurality of virtual product advertisements in the product advertisement bank, the processor 50 illustratively determines a prediction value based on the purchase history, wherein the prediction value corresponds to a likelihood that the customer will purchase an item from the retail enterprise 5 and/or from a particular one of the plurality of retail enterprise outlets or stores controlled by the retail enterprise 5, to which the limited term discount pricing of the virtual product advertisement is applicable, and with the processor. The processor may then illustratively identify for the customer in the virtual product advertisement bank at least one of the virtual product advertisements in the at least the subset of the plurality of virtual product advertisements based the prediction value thereof as described hereinabove in the context of virtual discount coupons as described hereinabove with respect to step 512 of the process 500 illustrated in FIG. 5.

As described briefly above, a product advertisement bank, e.g., stored in or as part of the virtual coupon bank 410 or stored in another portion of the database 402 may, in some embodiments, contain the plurality of limited term virtual product advertisements. In some alternate embodiments, the product advertisement bank, e.g., stored in or as part of the virtual coupon bank 410 or stored in another portion of the database 402 may, contain a plurality of product advertisement repositories each containing a plurality of such limited term virtual product advertisements for purchasable items specific to a different one of the plurality of retail enterprise outlets controlled by the retail enterprise. In such embodiments, the processor 50 may be operable to process the plurality of limited term virtual product advertisements as just described for each of the plurality of retail enterprise outlets for each customer member of the EMS, or may alternatively be operable for process the plurality of limited term virtual products as just described only for one of the plurality of retail enterprise outlets selected by a customer for viewing and/or processing of limited term product advertisements applicable to the selected one of the plurality of retail enterprise outlets. In such cases, determining the prediction value may comprise, for each virtual product advertisement in at least a subset of the plurality of virtual product advertisements in the one of the plurality of product advertisement repositories, determining with the processor 50 a prediction value based on the customer's purchase history, wherein the prediction value corresponds to a likelihood that the customer will purchase from the selected one of the plurality of retail enterprise outlets an item to which the limited term discount pricing of the virtual product advertisement is applicable. The processor 50 may then be operable to identify for the customer in the one of the plurality of virtual product advertisement repositories at least one of the virtual product advertisements in the at least the subset of the plurality of virtual product advertisements in the one of the plurality of product advertisement repositories based the prediction value thereof.

In some embodiments, the processor 50 may be further operable to, for each virtual product advertisement in the at least the subset of the plurality of virtual product advertisements in the one of the plurality of product advertisement repositories, determine, based the customer's purchase history, either or both of a first score value proportional to a total number of items previously purchased by the customer from the retail enterprise to which the limited term discount pricing of a virtual product advertisement was applicable, and a second score value proportional to a number of items within one of a plurality of different product advertisement categories contained in the product advertisement bank or in the one of the plurality of product advertisement repositories in which the virtual product advertisement is a member, previously purchased by the customer from the retail enterprise to which the limited term discount pricing of a virtual product advertisement was applicable, and to then determine a composite score for the virtual discount coupon as a function of the prediction value and the at least one of the first and second score values. In such embodiments, the processor 50 is illustratively operable to identify for the customer in the one of the plurality of virtual product advertisement repositories at least one of the virtual product advertisements in the at least the subset of the plurality of virtual product advertisements having a composite score that is within a predefined range of composite scores. Alternatively or additionally, the processor 50 may be operable to identify at least one of the virtual product advertisements in the at least the subset of the plurality of virtual product advertisements using any one or more of the techniques described hereinabove with respect to steps 510 and/or 512 of the process 500 illustrated in FIG. 5.

In some embodiments, the processor 50 may be operable to, for each virtual product advertisement in at least a subset of the plurality of virtual product advertisements in the one of the plurality of product advertisement repositories, modify the prediction value with a prediction weighting value, and/or modify one or both of the first and second score values with at least one of first and second weighting values respectively, and to then determine the composite score as a function of the prediction value modified by the prediction weighting value and of the first and/or second score value modified by the first and/or second weighting value respectively.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

What is claimed is:

1. A method for presenting virtual discount coupons to customers of a retail enterprise, the method comprising:
accessing with a processor a virtual coupon repository stored in a database and associated in the database with a customer of the retail enterprise, the virtual coupon repository containing a plurality of virtual discount coupons each redeemable by the retail enterprise against at least one item purchasable from the retail enterprise,
accessing with the processor a purchase history stored in the database and associated in the database with the customer, the purchase history identifying items previously purchased by the customer from the retail enterprise,
for each virtual discount coupon in at least a subset of the plurality of virtual discount coupons in the virtual coupon repository, determining with the processor a prediction value based on the purchase history, the prediction value corresponding to a likelihood that the customer will purchase an item from the retail enterprise against which the virtual discount coupon is redeemable by the retail enterprise, and
with the processor, identifying for the customer in the virtual coupon repository at least one of the virtual discount coupons in the at least the subset of the plurality of virtual discount coupons based the prediction value thereof.

2. The method of claim 1 wherein the at least the subset of the plurality of virtual discount coupons includes one of all of the plurality of virtual discount coupons and a number of the plurality of virtual discount coupons that is less than all of the plurality of virtual discount coupons.

3. The method of claim 1 further comprising sorting with the processor at least some the virtual discount coupons in the at least the subset of the plurality of virtual discount coupons based the prediction values thereof in order of the likelihood that the customer will purchase items against which corresponding ones of the virtual discount coupons are redeemable by the retail enterprise,
and wherein identifying the at least one of the virtual discount coupons comprises identifying for the customer in the virtual coupon repository one or more of the virtual discount coupons resulting from the sorting.

4. The method of claim 3 wherein sorting with the processor the at least some of the virtual discount coupons produces a descending sorted list of virtual discount coupons in which a virtual discount coupon at one end of the sorted list is redeemable by the retail enterprise against an item determined by the processor to have greatest likelihood of being purchased by the customer from the retail enterprise and in which a virtual discount coupon at an opposite end of the sorted list is redeemable by the retail enterprise against an item determined by the processor to have least likelihood of being purchased by the customer from the retail enterprise,
and wherein identifying the at least one of the virtual discount coupons comprises identifying for the customer in the virtual coupon repository one or more of the virtual discount coupons at or near the one end of the sorted list.

5. The method of claim 1 further comprising:
accessing with the processor a coupon activity history stored in the database and associated in the database with the customer, the coupon activity history containing identifications of virtual discount coupon processing actions previously executed by the customer on one or more virtual discount coupons previously contained in the virtual coupon repository associated with the customer, and
for each virtual discount coupon in the at least the subset of the plurality of virtual discount coupons in the virtual coupon repository,
determining with the processor, based on one or more of the identifications of virtual discount coupon processing actions contained in the coupon activity history, at least one of:
a first score value proportional to a total number of virtual discount coupons that were previously clipped by the customer within the virtual coupon repository for redemption by the retail enterprise against corresponding items purchased from the retail enterprise,
a second score value proportional to a number of virtual discount coupons, within one of a plurality of different coupon categories contained in the virtual coupon repository in which the virtual discount coupon is a member, that were previously clipped by the customer within the virtual coupon repository for redemption by the retail enterprise against corresponding items purchased from the retail enterprise, and
a third score value proportional to a number of virtual coupons previously hidden by the customer from view within the virtual coupon repository, and
determining a composite score for the virtual discount coupon as a function of the prediction value and the at least one of the first, second and third score values,
and wherein identifying comprises identifying for the customer in the virtual coupon repository at least one of the virtual discount coupons in the at least the subset of the plurality of virtual coupons having a composite score that is within a predefined range of composite scores.

6. The method of claim 5 wherein identifying comprises identifying for the customer in the virtual coupon repository at least one of the virtual discount coupons in the at least the subset of the plurality of virtual coupons having a composite score that is greater than a predefined composite score.

7. The method of claim 5 further comprising, for each virtual discount coupon in the at least the subset of the plurality of virtual discount coupons in the virtual coupon repository, modifying the prediction value with a prediction weighting value, modifying the at least one of the first, second and third score values with at least one of first, second and third weighting values respectively, and determining the composite score as a function of the prediction value modified by the prediction weighting value and of the at least one of the first, second and third score values modified by the at least one of the first, second and third weighting values respectively.

8. The method of claim 5 further comprising sorting the composite scores in descending order,
and wherein identifying comprises arranging for the customer in the virtual coupon repository one or more of the virtual discount coupons according to the sorted composite scores.

9. The method of claim 1 further comprising automatically clipping, with the processor, for redemption by the retail enterprise at least one of the virtual discount coupons identified in the virtual coupon repository by the processor based on the prediction value thereof.

10. The method of claim 9 wherein automatically clipping comprises automatically clipping the at least one of the virtual discount coupons identified in the virtual coupon repository by the processor based on the prediction value thereof in response to selection by the customer of a selectable, automatic clipping feature available in the virtual coupon repository.

11. A system for presenting virtual discount coupons to customers of a retail enterprise, the system comprising:
a virtual coupon repository database including a plurality of virtual coupon repositories each associated with a different one of a plurality of customers of the retail enterprise, each of the plurality of virtual discount coupon repositories containing a plurality of virtual discount coupons each redeemable by the retail enterprise against at least one item purchasable by an associated one of the plurality of customers from the retail enterprise,
a purchase history database including a plurality of purchase histories each associated with a different one of the plurality customers, each of the plurality of purchase histories containing identifications of items previously purchased by an associated one of the plurality of customers from the retail enterprise,
a processor, and
a memory having instructions stored therein which, when executed by the processor, cause the processor to access the one of the plurality of virtual coupon repositories associated in the virtual coupon repository database with one of the plurality of customers, access the one of the purchase histories associated in the purchase history database with the one of the plurality of customers, for each virtual discount coupon in at least a subset of the plurality of virtual discount coupons in the one of the plurality of virtual coupon repositories, determine a prediction value based on identifications of items in the one of the plurality of purchase histories previously purchased by the one of the plurality of customers, the prediction value corresponding to a likelihood that the one of the plurality of customers will purchase an item from the retail enterprise against which the virtual discount coupon is redeemable by the retail enterprise, and to identify for the customer in the one of the virtual coupon repositories at least one of the virtual discount coupons in the at least a subset of the plurality of virtual discount coupons based the prediction value thereof.

12. The system of claim 11 wherein the instructions stored in the memory further include instructions which, when executed by the processor, cause the processor to sort the virtual discount coupons in the at least the subset of the plurality of virtual discount coupons in order of the likelihood that the one of the plurality of customers will purchase items against which corresponding ones of the virtual discount coupons are redeemable by the retail enterprise, and to identify the at least one of the virtual discount coupons by identifying for the one of the plurality of customers in the one of the plurality of virtual coupon repositories one or more of the virtual discount coupons resulting from the sorting.

13. The system of claim 11 wherein the instructions stored in the memory further include instructions which, when executed by the processor, cause the processor to sort the virtual discount coupons in the at least the subset of the plurality of virtual discount coupons to produce a descending sorted list of virtual discount coupons in which a virtual discount coupon at one end of the sorted list is redeemable by the retail enterprise against an item determined to have greatest likelihood of being purchased by the one of the plurality of customers from the retail enterprise and in which a virtual discount coupon at an opposite end of the sorted list is redeemable by the retail enterprise against an item determined to have least likelihood of being purchased by the one of the plurality of customers from the retail enterprise, and to identify the at least one of the virtual discount coupons by identifying for the one of the plurality of customers in the one of the plurality of virtual coupon repositories one or more of the virtual discount coupons at or near the one end of the sorted list.

14. The system of claim 11 further comprising a coupon activity history database including a plurality of coupon activity histories each associated with a different one of the plurality customers, each of the plurality of coupon activity histories containing identifications of virtual coupon processing actions previously executed by an associated one of the plurality of customers on one or more virtual discount coupons previously contained in the one of the plurality of virtual coupon repositories associated with the one of the plurality of customers,
wherein the instructions stored in the memory further include instructions which, when executed by the processor, cause the processor to, for each virtual discount coupon in the at least the subset of the plurality of virtual discount coupons in the one of the virtual coupon repositories,
determine, based on one or more of the identifications of virtual discount coupon processing actions contained in the one of the coupon activity histories associated in the coupon activity database with the one of the plurality of customers, at least one of:
a first score value proportional to a total number of virtual discount coupons that were previously clipped by the one of the plurality of customers within the one of the plurality of virtual coupon repositories for redemption by the retail enterprise against corresponding items purchased from the retail enterprise,
a second score value proportional to a number of virtual discount coupons, within one of a plurality of different coupon categories contained in the one of the virtual coupon repositories in which the virtual discount coupon is a member, that were previously clipped by the one of the plurality of customers within the one of the plurality of virtual coupon repositories for redemption by the retail enterprise against corresponding items purchased from the retail enterprise, and
a third score value proportional to a number of virtual coupons previously hidden by the one of the plurality of customers from view within the one of the plurality of virtual coupon repositories, and
determine a composite score for the virtual discount coupon as a function of the prediction value and the at least one of the first, second and third score values,
and to identify for the one of the plurality of customers in the one of the plurality of virtual coupon repositories at least one of the virtual discount coupons by identifying at least one of the virtual discount coupons in the at least the subset of the plurality of virtual coupons having a composite score that is within a predefined range of composite scores.

15. The system of claim 14 wherein the instructions stored in the memory further include instructions which, when executed by the processor, cause the processor to identify the at least one of the virtual discount coupons in the at least the subset of the plurality of virtual coupons by identifying at least one of the virtual discount coupons having a composite score that is greater than a predefined composite score.

16. The system of claim 14 wherein the instructions stored in the memory further include instructions which, when executed by the processor, cause the processor to, for each virtual discount coupon in the at least the subset of the plurality of virtual discount coupons in the one of the virtual coupon repositories, modify the prediction value with a prediction weighting value, modify the at least one of the first, second and third score values with at least one of first, second and third weighting values respectively, and determine the composite score for the virtual discount coupon as a function of the prediction value modified by the prediction weighting value and of the at least one of the first, second and third score values modified by the at least one of the first, second and third weighting values respectively.

17. The system of claim 14 wherein the instructions stored in the memory further include instructions which, when executed by the processor, cause the processor to sort the composite scores in descending order,
and to identify the at least one of the virtual discount coupons in the at least the subset of the plurality of virtual coupons by arranging for the one of the plurality of customers in the one of the plurality of virtual coupon repositories one or more of the virtual discount coupons according to the sorted composite scores.

18. The system of claim 14 wherein the instructions stored in the memory further include instructions which, when executed by the processor, cause the processor to automatically clip for redemption by the retail enterprise at least one of the virtual discount coupons identified in the one of the plurality of virtual coupon repositories based on the prediction value thereof.

19. The system of claim 18 wherein the instructions stored in the memory further include instructions which, when executed by the processor, cause the processor to automatically clip the at least one of the virtual discount coupons by automatically clipping the at least one of the virtual discount coupons identified in the one of the plurality of virtual coupon repositories in response to selection by the one of the plurality of customers of a selectable, automatic clipping feature available in the one of the plurality of virtual coupon repositories.

20. A system for presenting virtual discount coupons to customers of a retail enterprise, the system comprising:
a virtual coupon repository associated with a customer of the retail enterprise, the virtual coupon repository containing a plurality of virtual discount coupons each redeemable by the retail enterprise against at least one item purchasable from the retail enterprise,
a purchase history database containing a purchase history associated with the customer, the purchase history identifying items previously purchased by the customer from the retail enterprise,
a coupon activity history database containing a coupon activity history associated with the customer, the coupon activity history containing identifications of virtual discount coupon processing actions previously executed by the customer on one or more virtual discount coupons previously contained in the virtual coupon repository associated with the customer,
a customer purchase history management module to access the purchase history database,
a customer virtual coupon activity history management module to access the coupon activity history database,
a virtual coupon processing module to determine, for each virtual discount coupon in at least a subset of the plurality of virtual discount coupons in the virtual coupon repository,
a prediction value based on identifications of items in the purchase histories previously purchased by the customer, the prediction value corresponding to a likelihood that the customer will purchase an item from the retail enterprise against which the virtual discount coupon is redeemable by the retail enterprise,
at least one of a first score value, a second score value and a third score value, based on one or more of the identifications of virtual discount coupon processing actions contained in the coupon activity history, the first score value proportional to a total number of virtual discount coupons that were previously clipped by the customer within the virtual coupon repository for redemption by the retail enterprise against corresponding items purchased from the retail enterprise, the second score value proportional to a number of virtual discount coupons, within one of a plurality of different coupon categories contained in the virtual coupon repository in which the virtual discount coupon is a member, that were previously clipped by the customer within the virtual coupon repository for redemption by the retail enterprise against corresponding items purchased from the retail enterprise, and the third score value proportional to a number of virtual coupons previously hidden by the customer from view within the virtual coupon repository, and
a composite score for the virtual discount coupon as a function of the prediction value and the at least one of the first, second and third score values, and
a virtual coupon arrangement module to identify for the customer in the virtual coupon repository at least one of the virtual discount coupons in the at least the subset of the plurality of virtual coupons having a composite score that is within a predefined range of composite scores.
